(19) United States
(12) Patent Application Publication
(10) Pub. No.: US 2018/0096560 A1
(43) Pub. Date: Apr. 5, 2018

(54) GAME RANDOM NUMBER GENERATION AND AUDITING SYSTEMS AND METHODS

(71) Applicant: Joseph Y. LEE, Buena Park, CA (US)

(72) Inventor: Joseph Y. LEE, Buena Park, CA (US)

(21) Appl. No.: 15/564,966

(22) PCT Filed: Apr. 7, 2016
(86) PCT No.: PCT/US16/26403

§ 371 Date: Oct. 6, 2017

(30) Foreign Application Priority Data
Apr. 8, 2015 (US) 62144731

(51) Int. Cl. G07F 17/32; G06Q 30/00; G06Q 50/34

(52) U.S. Cl. CPC G07F 17/3241; G06Q 30/018; G07F 17/3262; G07F 17/3225; G06Q 50/34

(57) ABSTRACT

For a game of chance, a selected game value is generated. The selected game value is used to determine whether the player is a winner or a loser. An historical value for a financial asset used to generate the selected game value is displayed. The historical value is generated after the input, receives the game input from, the player and before the display displays the selected game value. The historical value is generated by a financial exchange independent of the gaming table. The historical value generated by the financial exchange is verifiable by an internet query to an information server. An amount of detail displayed for the historical value is based on the selection received from the player.

### TECHNICAL FIELD

The present disclosure relates to a method for auditing compliance of use of financial data, more specifically, used in a game that derives random or almost random numbers from the financial data.

### BACKGROUND ART

Online gaming websites use random number generators for games such as blackjack, baccarat, poker, roulette and craps. Gaming at these online sites presents risks for players because how it is operated is not easily transparent to the player. It is very difficult to determine the integrity of a particular card, dice, roll, or other typically random result in these games of chance online. Even with information provided, it is often very difficult to verify the integrity of the information.

Many players suspect that online games of chance such as Blackjack are rigged. That is one of the top concerns for players that consider playing blackjack or other online games of chance on the interact, even if it is a human dealer on the internet web site. For example, some players suspect that the cards are dealt in certain patterns so that certain hands will be specifically chosen by the site, resulting in bad losses for other players. Most online poker sites use a RNG (Random Number Generator) to randomly choose cards from a 52 card deck on every singly hand. But it would be virtually impossible to prove to the satisfaction of a suspicious player that the cards were in fact chosen randomly. The authenticity of online games is much more difficult for a player or independent observer to verify.

### DISCLOSURE OF INVENTION

### Technical Problem

A method to determine fairly accurately how many times the financial data is used by a licensee casino or other licensee is necessary for accurate accounting.

### Solution to Problem

The present disclosure provide a method for auditing compliance of use of financial data used in a game that derives random or almost random numbers from the financial data, comprising: providing, through a communication network that implements communication between computers, the financial data to a licensee of the financial data, the financial data being provided by a licensor of the financial data; using the financial data, by the licensee of the financial data, to derive the random or almost random numbers; making the financial data and an audit code accessible to a game client through a communication network that implements communication between computers; requesting the licensor to change the audit code, the requesting being made by the game client to the licensor; and, monitoring the audit code made accessible by the licensor to the game client to detect whether the audit code reflects the audit code change requested by the game client.

### Advantageous Effects of Invention

A method for determining fairly accurately how many times the financial data is used by a licensee casino or other licensee is introduced.

### BRIEF DESCRIPTION OF DRAWINGS

FIG. 1A is a flow chart illustrating a method according to an implementation.

FIG. 1B is a flow chart illustrating a method according to another implementation.

FIG. 2 is a flow chart illustrating a method according to another implementation.

FIG. 3 is a flow chart illustrating a method according to another implementation, especially focusing on time details.

FIG. 4 is a flow chart illustrating a method according to another implementation, for use in roulette.

FIG. 5 is a flow chart illustrating a method according to another implementation, for use in blackjack.

FIG. 6 is a flow chart illustrating a method according to another implementation, for use in craps.

FIG. 7 is a schematic view of a blackjack table and components according to an implementation.

FIG. 8 is a simplified block diagram of hardware utilized in various implementations.

FIG. 9 is a flow chart illustrating a method according to another implementation.

FIG. 10A is a simplified block diagram of hardware utilized in various implementations.

FIG. 10B is a simplified block diagram of hardware utilized in various implementations.

FIG. 11A is a flow chart illustrating a method according to an implementation.

FIG. 11B is a flow chart illustrating a method according to another implementation.

FIG. 12 is a flow chart illustrating a method according to another implementation.

FIG. 13 is a flow chart illustrating a method according to another implementation, focusing on the player.

FIG. 14 is a flow chart illustrating a method according to another implementation, focusing on a client-server.

FIG. 15 is a flow chart illustrating a method according to another implementation, focusing on an operator/auditor.

FIG. 16 is a flow chart illustrating a method according to another implementation.

FIG. 17 is a flow chart illustrating a method according to another implementation.

### BEST MODE FOR CARRYING OUT THE INVENTION

An embodiment of the present disclosure provides a method for auditing compliance of use of financial data used in a game that derives random or almost random numbers from the financial data, comprising: providing, through a communication network that implements communication between computers, the financial data to a licensee of the financial data, the financial data being provided by a licensor of the financial data; using the financial data, by the licensee of the financial data, to derive the random or almost random numbers; making the financial data and an audit code accessible to a game client through a communication network that implements communication between computers; requesting the licensor to change the audit code, the requesting being made by the game client to the licensor; and, monitoring the audit code made accessible by the licensor to the game client to detect whether the audit code reflects the audit code change requested by the game client.

The game client may be an auditor that has initiated a game session.

The licensor may provide to the licensee the audit code which is made accessible to the game client.

The game client obtains contact information for the licensor from a trusted source,

Requesting the licensor to change the audit code may include using a unique identifier from the game client.

The method may additionally comprise: initiating a game session, by the game client, that connects the game client to the licensor; receiving, by the game client from the licensee, a unique identifier; and, determining whether the unique identifier is from an approved licensee.

The method may additionally comprise: activating the game client to play the game, including starting a game session that has a unique identifier that identifies the game session.

The method may additionally comprise obtaining the financial data by the licensor from a financial data provider.

An embodiment of the present disclosure provides a system that audits compliance of use of financial data used in a game that derives random or almost random numbers from the financial data, the system comprising: a communication network that implements communication between computers, a licensor computing server that provides the financial data; a licensee computing server that receives the financial data from the licensor server and derives from the financial data the random or almost random numbers used in the game; a game client server that a game player uses to play the game, the financial data and an audit code being accessible to the game client server through the communication network; wherein to audit compliance of use of the financial data the game client requests the licensor to change the audit code and then monitors the audit code made accessible by the licensor to the game client to detect whether the audit code reflects the audit code change requested by the game client.

When the game client initiates a game that connects the game client to the licensor, the game client may receive from the licensee a unique identifier which can be used to determine whether the unique identifier is from an approved licensee.

### MODE FOR THE INVENTION

Auditing is defined as a systematic examination of books, accounts, documents and vouchers of an organization to ascertain how far the financial statements present a true and realistic view of the concern. Any subject matter may be audited. Auditing is an attempt to ensure that the books of accounts are properly maintained by the concern as required by the contract at hand or by the law. It is a systematic and independent examination of data, records, operations, and performances (not only financial) of a business or enterprise for a given purpose. In most auditing cases, the auditor perceives and recognizes the question at hand, collects evidence, valuates the same and on this basis forms a judgment which is communicated via the audit report. Auditing is an unbiased examination and evaluation of the financial statements of an organization. It can be done internally (by employees of the organization) or externally (by an outside firm).

Financial audits are often performed to ascertain the validity and reliability of the information provided, as well as to make an assessment of a particular system's internal control. As a result of this an often independent third party can express an opinion of the system (business, etc) in question. The opinion obviously will depend on the information provided.

So, the ability of the first party to audit the second party becomes necessary, “but verify” is an old Russian proverb that many find useful.

When it comes to financial contractual obligations, you need to be able to validate the parties accounting and have appropriate controls in place. When organizations know they could be audited at any time it will provide the motivation for them to then ensure their accounting is accurate and that they meet all their compliance requirements. So, a contract including an audit clause between the first party and second party is very useful and necessary. However, there may be times between audits that the second party is not in honest and not accounting accurately the way they use the financial data provided by the first party. Also, audits can be timeconsuming and difficult and strain the relationship between parties.

An audit clause is frequently included in long-term contracts to oblige a second party to maintain records relating to its performance of the contract and provide the first party with copies of, or access to, them. Also, although the exact scope of what is covered by an audit clause depends on the wording, such clauses may potentially result in the second party being obliged to make available a huge range of documents. This is not only a problem for the second party (in the amount of work required to fulfill the obligation), but also difficult for the first party in that there is a tremendous amount of work to review and sift through that mountain of data. Again, this can severely strain the business relationship between the two parties.

Audit provisions are a fairly common feature of a wide range of intellectual property and technology agreements. It is a practical way to monitor key aspects of a commercial deal such as the level of data security provided, accuracy of billing and compliance with license restrictions.

Clearly, financial data is valuable and although its value depreciates with time, real time financial data at ultra latency speeds can be very expensive. Data providers who provide other parties with such data clearly value the data they provide and proof of this is not necessary. But, the long contractual agreements that these financial data providers require of their customers is evidence of how much they value their data and that they do not wish their customers to disseminate that financial data, without authority.

Again, enforcing an audit is complex and the legal world is full of cases that have ended with disastrous results for both parties. The complexity of drafting and enforcing these audit clauses include questions such as who is entitled to access, location of access, are there exclusions from audit scope, what are the specific consequences of the audit, what comprises a breach and the list goes on and on.

In the method of the current invention, many of the difficulties of current audit methods are overcome in this particular field of providing financial data for a cost.

In the method of the current invention, an auditing method is provided in conjunction with delivery of financial data to the licensor or game provider. The financial data use can be extremely closely monitored using this method. For example, in a situation where a game provider has licensed the use of the financial data for casino or other gaming, there would typically be a contract where the game provider (licensee in this situation) would pay the licensor (party that provides the financial data, or first party) a certain fee. The fee paid would typically be based on the level of usage of the financial data provided by the first party. The first party (or licensor) would prefer highly accurate counts of the usage of the financial data by the licensee. Again, typically, a contract would be in place between the first party and the licensee (game provider) allowing the first party access to the game provider' internal operating system including computers, software, accounting, and financial statements. However, it would still be difficult for the licensor (first party) to monitor accurately the licensee' use of the financial data provided, the frequency of use, and whether the game provider (second party) is manipulating the actual use of the financial data provided. The method of the current invention discloses a systematic method to assess and audit the use of the financial data provided to a second party in a very simple way that would avoid having to investigate the internal systems of the second party' business and systems. The method of the current invention especially relates to a method of using financial data as a random number generator for games of chance and the method to audit the financial data usage. The method of using the financial data as a random number generator for games of chance is then followed by the audit method of the same.

Implementations are disclosed for providing random or almost random number for use in games of chance and then providing almost instant verification of the almost random or random number in a way that the players can be certain that no one has access to the random number. For example, the highly fluctuating smallest digits of financial data such as the S&P 500 Index (Standard & Poor' 500) are used to provide a random or almost random number which is then converted into a card, dice, or wheel (whatever the game of chance may be) using algorithms. The random or almost random number that is generated is posted on a web site so that a player can see the random number and the corresponding card in historical fashion.

Random numbers for games of chance are verifiable almost immediately after the random number is selected, by numerous independent parties. The current implementation can be used for almost all games of chance on the internet or accessed elsewhere. Current online gaming websites that use random number generators include games such as blackjack, baccarat, poker, roulette and craps. Gaming at these online sites presents risks for players because how it is operated is not easily transparent to the player. It is very difficult to determine the integrity of a particular card, dice, roll, or other typically random result in these games of chance line. Even with information provided, it would be almost impossible to verify the integrity of the information.

Many players believe that online games of chance such as Blackjack are rigged. That is one of the top concerns for players that consider playing blackjack or other online games of chance on the internet, even if it is a human dealer on the internet web site. Many people suspect online poker to be fixed or rigged. To clarify, when people say that online poker is rigged or fixed, they believe that the cards are dealt in certain patterns so that certain hands will be specifically chosen by the site, resulting in bad losses for other players. Most online poker sites use a RNG (Random Number Generator) to randomly choose cards from a 52 card deck on every singly hand. But it would be virtually impossible to prove to the satisfaction of a suspicious player that the cards were in fact chosen randomly. The authenticity of online games is much more difficult for a player or independent observer to verify.

In the method of the current implementation, there will be no doubt in the mind of even the most doubting player, that no one knows what card will be dealt prior to the hand being dealt. Because everyone can be assured that the randomness of the card distribution is unknown by anyone in advance and then after the cards are dealt, verifiable by all involved within seconds, there will be acceptance of the “beat” without escalation and irate phone calls to the online gaming site. This will result in much less requirement of a customer service call center and the concomitant expensive resources to maintain a large customer service center.

Online poker sites often use a third party or independent organization to determine the adequacy of their random number generators and systems since fairness is a very important part of any online gaming experience.

The method of this implementation can be used to generate random numbers for games of chance on the internet via a website. Current online gambling sites provide random cards in generally the following method. A random number generator (RNG) is used to provide a random number. The random number is input into an algorithm that converts the random number into a card. Random number generators have applications in gambling, statistical sampling, computer simulation and other areas where producing an unpredictable result is desired.

In the method of the current implementation, because the random number is easily verified almost instantly by many possible sources, the timing of the player' interaction with the game becomes very important.

Truly random numbers are the essence of any fair online gaming and independent assessment to confirm the reliability and security of the random number generator is of value to the potential customer. Current online gaming websites use a third-party to assess their hardware and software. The independent third party can confirm that the software meets certain gaming software criteria, but they cannot confirm that each hand is randomly dealt. Even given this type of scrutiny, players can suspect that the web site may not be complying at a later date or that the website did not truly turn over the software that is actually being used by the website. Many levels of trust are still required and there are many ways that the online gaming website could still manipulate results. The third-party testers will analyze the source code and run statistical tests to ensure that the RNG (random number generator) behaves randomly. However, there are still many flaws. For example, in between the testing (possibly years apart), different software can be used. There is no convenient easy way to identify at the time a player is actually playing that the software and random number generator is working fairly.

In the method of the current implementation, the random numbers generated and used in determining the cards that are dealt can be verified almost immediately every time by the player. In the method of the current implementation, the player can verify the random number used in his or her particular game through hundreds of independent sources at the time of play or at a later time, as long as the player knows what day and time be played. This is a transparent system for generating random or almost random numbers for the use in gaming and will win the confidence and trust of players.

The method may also comprise a modular form where the player is sitting near the module and the player is not in a remote location, but nearby, and the game-play action of the player is transmitted to the processor of the module directly, not necessarily using a network.

Random number generators have many applications including gambling, statistical sampling, cryptography, lotteries and computer simulation. The methods of the current implementations have applications in all these fields.

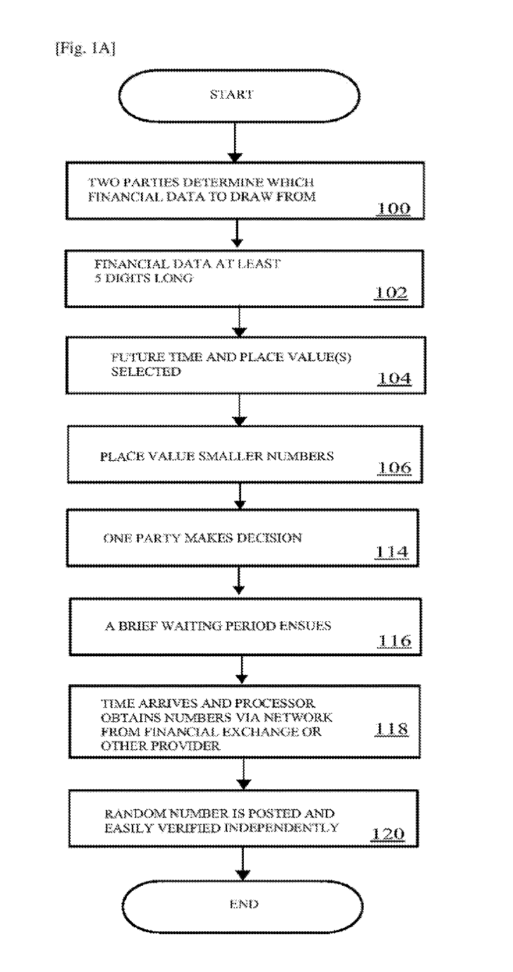

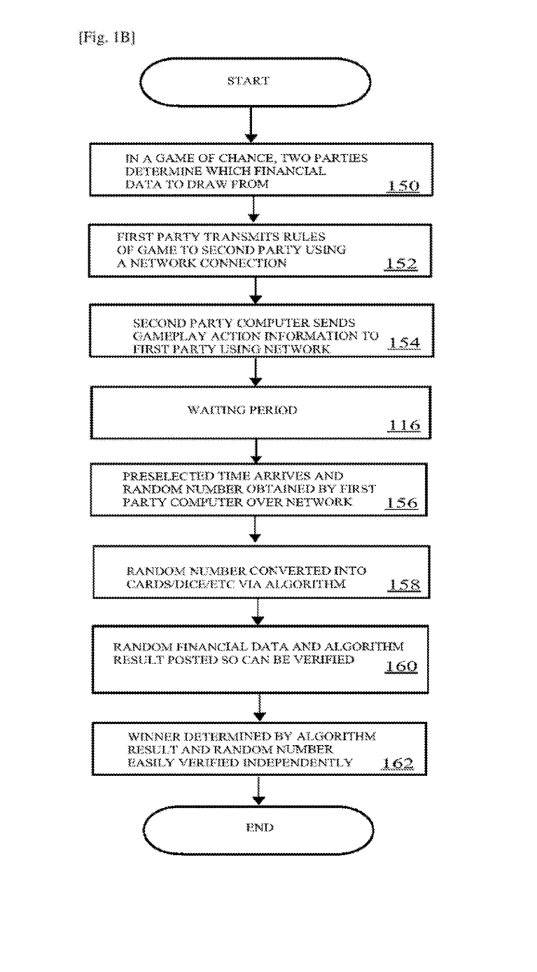

In an example implementation illustrated by FIG. 1A, in block 100 at least two parties agree which financial data to draw random numbers from. For example, financial data is historical values for a financial asset used to generate the selected game value. For example, the historical values are generated after the input receives the game input from the player and before the display displays the selected game value, the historical value being generated by a financial exchange independent of the gaming table. The historical value generated by the financial exchange is verifiable by an internet query to an information server.

In block 102 illustrates using financial data that provides a number that is at least 4 total digits in length but preferably five (5) digits or longer in length. A block 104 illustrates agreeing upon the exact future time from which the financial data number will be collected and agreeing upon the exact place values of the financial data number from which the random number(s) to be extracted will be selected. A selection received from the player indicates which financial asset will be used to generate a selected game value.

A block 106 illustrates confirming that the place aloe selected must be at least the third position to the right (from the left most number that is not zero). A block 114 illustrates having at least one party make a decision that may be affected favorably or unfavorably by the random number that is selected from the future time. A block 116 illustrates having that one party inform the other party of the decision with both sides agreeing how the random number will result in a favorable or unfavorable outcome based on the decision and having a waiting period between the decision and the extraction of numbers from the financial index. A block 118 illustrates extracting the number(s) from the pre-selected place value(s) of the financial data at the pre-selected time. A block 120 illustrates both sides being able to within seconds (or minutes) verify the random number generated through independent means.

FIG. 1B illustrates an example implementation that provides for online gaming with random data that can be easily verified. A block 150 illustrates setting rules of the game and rules regarding how to select random numbers from a particular financial data number at a particular time in the future, random numbers that cannot be known to the first party (e.g. “”or the second party (e.g. “”block 152 illustrates using a network connection to transmit information 152 to a remote player' client computer including information about rules of the game. A block 154 illustrates receiving information over the network connection about a game-play action from the player. A block 156 illustrates using the processor to obtain real time financial data information from a financial exchange (or other provider of real time financial data) via a network connection. A block 158 illustrates using a processor and an algorithm to convert the random portion of this financial data into cards, dice, roulette numbers, etc. A block 158 also illustrates using the processor and memory to process the game-play action using the random data from the financial data provider. A block 160 illustrates transmitting information to the remote player' computer regarding the outcome of the game-play action consistent with rules of the game. A block 162 illustrates transmitting the random numbers acquired from the financial data provider to the player' processor, so the player can easily independently verify the random numbers to be accurate and truthful.

In many gaming situations, a high degree of randomness that is not completely random may be preferred if that random number can be verified easily, especially if neither party knows which side will benefit from the lack of complete randomness. The tenths number position of the S&P 500 Index and the hundredths number position of the S&P 500 Index may approach true randomness but is verifiable by many sources in real time data.

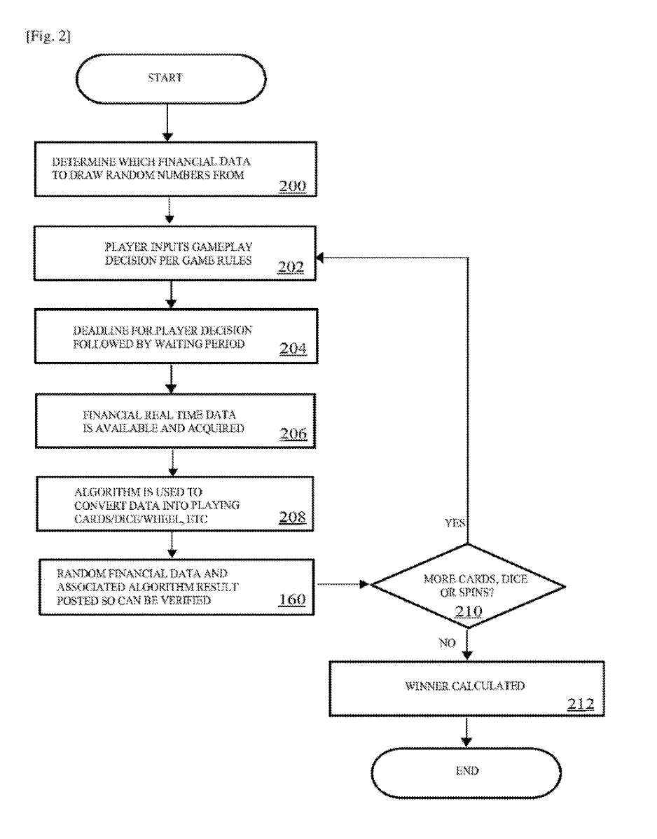

FIG. 2 is a simplified flowchart explaining how the rules of a game to be played are displayed and made easily available. For example, the game of chance will require a random number or an almost random number. For example, the random number will be acquired from financial data.

In a block 200, the description of the financial data number to be used in the game is displayed. For example, the financial data number to be used constantly fluctuates when the market is open. For example, some financial data, such as the S&P 500 index, are published every 15 seconds. The S&P 500 Index, for example, is maintained by Standard & Poor' It is a stock market index based on the market capitalizations of 500 leading companies that are publicly traded in the U.S. stock market. It is one of the most commonly followed equity indices in the world. Players can be confident that manipulating the tenths and hundreds numbers of this index 15 to 30 seconds before it is disseminated would be impossible.

Rapidly changing financial data that is widely available in real time such as the S&P 500 Index, DJIA and Nasdaq 100 Index are ideal. The larger the number of significant digits (Dow Jones Industrial Average index has 7 significant digits, e.g. 14,909.60 and the last two digits fluctuate relatively unpredictably), and the more the particular index fluctuates, the more likely the last two digits will be random). Financial indices from Europe and Asia such as the FTSE100, DAX, CAC40, Nikkei 225, Hang Seng, and Straight Times are also ideal because of the liquidity and large size. Individual company stock data may be used if sufficiently large. Mutual fund data, ETF data, bond data, Volume data, commodity data and futures data can also be used. Some markets are closed at some times, but there is usually a financial market somewhere in the world that is open and a corresponding financial index that is fluctuating. A combination of the smallest value digits (e.g., for S&P 500 Index value of 1605.28, the smallest place value number would be the “in the hundredths place) from different indices may be used. The tenths place is immediately to the right of the decimal point and in the example 1605.28, the number in the tenths place (TPN) is the “The number in the hundredths place (HPN) in this example 1605.28 is the “The number in the hundredths place would normally be more random than number in the tenths place, given that the market is open and being traded. In contrast, the number in the hundreds place in this example 1605.28 is “and would not be very random at all.

Financial data is more readily available in real time in more places than almost any data in the world. Although most people do not believe stock data to be random, the “”data, the “”number and the “”number is fairly random, with the smaller “”number being much more random than the “”number. For example, in the S&P 500 Index data, which is constantly fluctuating during the day, the number may be 14,131.25. At any given minute, the “”number 2 and the “”number 5 will fluctuate and likely change in a close to random fashion. Although in the current implementation, the “”place number and the “”place number of the S&P Index is used as the random number provider, any stock Index number such as the DJIA or Nasdaq 100 Index or foreign indices could be used.

Many other variations are possible but based on the premise that the number provided fluctuates readily to be able to provide reasonably almost random numbers at apace where players can play the game. Currently, among financial data that is readily available, the tenths place and hundredths place are the most random digits. However, the thousandths place (third digit to the right of the decimal point), the fourth digit to the right of the decimal point, the fifth digit to the right of the decimal point, and so on and so on, provide additional random numbers but are not currently easily available in real time. Typically, the digits to the right of the decimal place will be used to provide the random or almost random numbers for the method of this implementation. However, if financial data presents in a form such as 123,456.78, then in this number, beginning with the leftmost nonzero digit (in this case, “and extending to the right, a number that is at least the third position (in this case, “from the leftmost nonzero digit, can also be used, but a number that is at least the north position from the leftmost nonzero digit is preferred (in this case, “The numbers that are more to the right than the fourth position from the leftmost nonzero number, can also be used (in this case, “”and “The total digits in this number is eight. For a financial number to be useful, the financial number (index or otherwise) must have at least 4 digits, but more than 5 digits is preferred.

Rarely, different providers of stock data may have slightly different numbers. However, even in those situations, it would be difficult to convince anyone that the stock data provider had an interest in the particular random number generated by the stock data and used in the game between the “”and the “”

Once a financial number thought to be random is generated by the method of this implementation, the output (smaller digits of the financial number as previously described) can undergo testing to see how random the number truly is. There are many such tests available to do this currently. One way to examine the degree of randomness of the output is “visual analysis” This creates a visualization of the numbers produced by the random number generator (RNG). The visual system of humans is adept at spotting patterns and this method is a fairly quick way of determining how well a given RNG is performing. The visual pattern produced by using www.random.org bitmap generator will create a much more random picture compared with the bitmap picture formed by the Rand ( ) function on Microsoft Windows which is a pseudo-random number generator (PRNG).

In yet another variation of this method, not illustrated in the drawings but easily appreciated by those of skill in the field, the random numbers provided by the financial indices could be used as the “”number for a traditional random number generator. To produce a pseudorandom sequence, all that is needed is the algorithm and an initial “”number.

It is with care that the term “digits” is avoided because “digits” is defined as the digits in a decimal number that are warranted by the accuracy of the means of measurement. If the S&P 500 Index is in the future reported as 1300.4567, then it could be argued that the thousandth' place “and the ten-thousandth' place “are not significant digits. However, that number would have a total of eight (8) digits in it and still be useful for the method of this implementation, although it would be difficult to prove that the most right two numbers are warranted by the accuracy of the means of measurement.

In a block 202 (shown in FIG. 2) a player makes an input into the game. Online gaming often involves software programs that permit a remote game player to enter bets, wagers and other necessary game-play actions (such as ante, post, call, raise, check-raise, all-in, double-down, split, side bet, insurance, stand/stick, stay, hit, draw, fold, etc). Game-play actions for online games are communicated via an input from the player. The input can be a touch (if using touch-screen), a mouse click, a key-press, or any other input device or method.

There is a time during which a player can make an input into the game. A block 204 illustrates a deadline. The deadline must be sufficiently far from the first “”or “”time of the fluctuating financial data. For example, the S&P 500 Index is published every 15 seconds. If data from only the start of every minute is used in this particular example, then the deadline for making a player input into the game would be at least 10 seconds prior to the published time of exactly 11:00:00. This is termed the waiting period illustrated by block 204.

In a block 206 of FIG. 2, financial real time data, once it becomes available, is acquired and the numbers from the pre-selected place values (e.g. tenths, hundredths, thousandths place values) are used as the random numbers in the game of chance (or game of skill with chance elements). Active traders worldwide need reliability, speed, and accuracy from their financial market data providers, so fortunately there is an abundance of financial real time data available all over the world.

Once the numbers are published and acquired from the pre-selected place values of the pre-selected financial data, these random numbers (or almost random numbers) can be converted using an algorithm into playing cards, dice, roulette pocket numbers, etc. as illustrated by a block 208. For converting into playing cards, shuffling algorithms are sometimes necessary even with the acquired random number. This can be done much in the same fashion that current random numbers are converted into cards in current games of chance, using algorithms such as the Fisher Yates algorithm.

In many card gambling games, either one or several decks of cards are shuffled. There are many algorithms that are used to shuffle a deck or decks of cards, such as the (e.g. Fisher-Yates shuffle and variants). The basic process of Fisher Yates shuffling is similar to randomly picking numbered tickets out of a hat, or cards from a deck, one after another until there are no more left. What the specific algorithm provides is a way of doing this numerically in an efficient and rigorous manner that, properly done, guarantees an unbiased result. This is a very good example of how to shuffle an array. All these shuffling algorithms still require a random number generator. Without question, the randomness provided by the shuffle are of considerable commercial importance in online gambling, where the randomness of the shuffling of simulated cards is critical.

Often in games of chance, one may want randomness within a certain number of options, such as in roulette, one would want to have an equal chance of the ball landing in any of 38 potential pockets. In cards, one would want to have an equal chance of any of the 52 cards in a deck to be dealt, or in the case of an ongoing game, an equal chance of any of the remaining cards in the deck to be dealt. There are many currently algorithms that can do this. In the method of the current implementation, numbers from a place value range from 1 to 10. For example, if the S&P 500 Index value was 1300.56, the tenths digit would be “but the number could be a “up through and including “So, the range for the random numbers generated would usually be different from the range of options in the game of chance (e.g. 52 cards, 38 roulette pockets). Once the random number is produced, currently available algorithms can convert those random numbers into playing cards, dice, etc fairly.

Even with the method of the current implementation, the random numbers provided may be biased. In this event, a simple algorithm such as John von Neumann' algorithm can fix simple bias and reduce correlation. Although the technique works no matter how the bits have been generated, it cannot assure randomness. What it can do is transform a biased random bit stream into an unbiased one. Again, the current method of providing random numbers may be used with any currently used algorithm.

In yet another implementation, to minimize the use of a complex algorithm, each card is assigned a number between 0.00 and 0.99, e.g., ace of diamonds would be 0.01 and two of diamonds would be 0.02, etc. Since there are 52 cards but 100 potential numbers with 2 significant digits that have a tenth number and a hundredth number, there will be occasions when the random number is 0.99 and there is no associated card with that number. Then, the player would wait another minute to receive his card. An alternative would be to have the same assigned numbers as above, but if the random numbers provided by the DJIA Index for example, did not match, the S&P 500 Index data would be used, as a backup. The legend should include these rules prior to play, to be fair. The chance 0.01 (ace of diamonds) showing up should be equal to the chance of 0.2 (two of diamonds) showing up and also equal to the chance of 0.99 showing up which would result in no card and a repeat of the cycle or using a second index for the random data.

In yet another implementation, each player could have a distinctly different assigning of numbers between 0.00 and 0.99 to each of the cards in the deck. This process of assigning numbers to cards could be randomized or selected by the house. The legend or key showing which playing card goes with which number would be visible prior to the actual card being dealt. In yet another version, the player could be allowed to match the numbers and the playing cards prior to the start of the game. The implementations of the last two paragraphs would be more suitable for an online game of blackjack with an infinite number of decks or an online roulette wheel, etc. In a game of cards that requires one deck and once a given card is used in a game and that card cannot be dealt again, an algorithm such as the Fisher Yates algorithm would be most efficient.

Continuing discussion of FIG. 2, once the algorithm is used to convert the random financial data, both the numbers used from the financial data and the associated algorithm result are posted so that it can be easily verified, as illustrated by a block 160. Verification of current online gaming software and web sites is difficult. In an online Internet version of the game Blackjack, a random card generator provides the cards. However, there may be suspicion on the part of the player that the “”is not being fair and that the cards that are dealt the player are not truly random. There is currently no simple way to really determine that the card dealt is actually random. For instance, the player may win hands when the player makes small bets and then when the player makes larger bets, the house may win. In this scenario, the player may start to become suspicious that the cards are not truly random, even if in fact the cards are random.

With current blackjack web sites that use current random number generators, it would be very difficult to prove or verify that the random numbers were not tampered with or manipulated for a particular game. The random numbers could be falsified and it would be difficult for any “”to ever prove in a court of law. The “”could cheat and it would be very difficult to definitively prove that the “”was cheating. However lack of ability to prove that the cards were manipulated is not proof that the cards were truthful. In the method of the current implementation, it would be easy to prove and substantiate that there was no manipulation of the random numbers that were generated by the method of the current implementation. In the method of this current implementation, the cards that are dealt (or dice, etc) are very close to random and yet can be completely verified almost immediately after the random numbers to be used (in card or dice conversion) are acquired from the financial data provider. Although not 100% random, a player can be assured that the “”has no idea what cards will be dealt. Also, the player can verify after the cards are dealt that there was no “”involved.

The method of the current implementation makes it easy to ensure that the random number generated and used in the game of chance has not been manipulated and that the random number was not known in advance by either party. The “”can know with certainty that the random number that created the card used in the game was not “”or manipulated. The “”can corroborate the random number used in the game at the specific time of say, 11:32:00, within seconds or even years later very easily as long as he knows what time the game was played. With this method, it would be very easy to prove that neither party was aware what random number would be created at 11:32:00 prior to that time.

Verify means to confirm or substantiate. Verify means to establish the truth or accuracy. Verification of the random numbers used in the method described herein is made possible because the random numbers produced by the method of the current implementation is so readily available in real time all over the world. Although many current online gaming websites have independent third parties verify the legitimacy of their RNG (random number generators), those verification activities may take place maybe once a year and verification would occur on systems provided by the website itself. Verification in real time of the random number generated for the card given the player is not possible with these systems. In the method of the current implementation, this real time verification of every card dealt is provided within seconds of the play action. This method provides at least almost random numbers; then complete confidence that it was impossible to manipulate this random number; and then allows easy verification of that almost random number. Verification of the random number (provided for the particular game) can be performed within seconds of the use of the random number by an independent party. The independent party verifying the random data only needs to know the particular index used and the time of data selection.

Many services and business offer “numbers” for the purposes of lotteries, games of chance, games, and gambling. However, even if one is to believe that the service is truly random, it is hard to verify that number. The random number that is generated is not easily available everywhere inexpensively. For example, if the “”generates a random number of 15 from Random.org at 11:32:00, it will be very difficult for the “”to actually confirm that that was the number the “”received from Random.org. In the method of the current implementation, an almost random number from the S&P 500 Index or other financial data is used to generate, say number 15, at 11:32:00. This number can be verified by almost anyone in real time if they have access to “time quotes” from any number of commercially available Internet sites that provide real time stock data.

If the “”were to use the services of random.org to obtain a random number of 15 for 11:32 am, for the “”to verify that that was actually the case, the “”would have to try to convince random.org to open its books and show the data, which might be very difficult to do, if at all possible, at the earliest days and possibly weeks after the game is played. It might require even a court order for a player to obtain that specific data from www.random.org. When using stock index data as described in this current implementation to provide the random number, the random number could be almost instantly and very easily verified without any red tape, without having to make any phone calls to private companies, without the aid of attorneys and without the need for a court order (all very expensive and time-consuming).

In a block 210 of FIG. 2, if it decided that there need be no more spins, cards, or dice (etc.), then the winner is calculated in a block 212 and the game is finished.

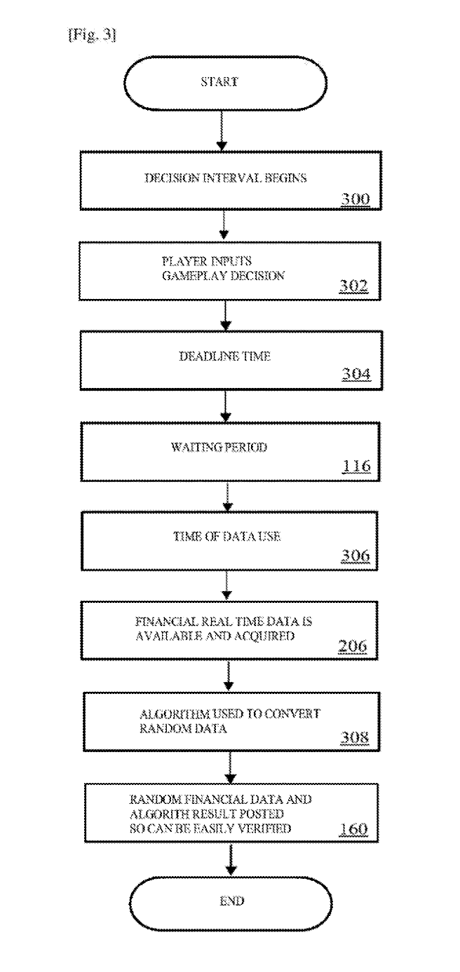

As illustrated in FIG. 3, definitions of certain boundaries regarding time are important to the proper functioning of the various implementations. Once a game begins, players typically have a time during which they can make a decision such as taking a card. This time has a beginning, illustrated by a block 300 and an end, which is referred to herein as the deadline time (DT), as illustrated in a block 304. Following the deadline time is the waiting period (WP), illustrated by block 116.

The Decision Interval (DI), shown in block 300, is the time period during which a player can make a decision to start the game, take a card, not take a card, place a bet, roll the dice, etc and then send the necessary signal/input to the website server (e.g., usually clicking on a button) regarding the player' decision. Typically, this would be a 15 second duration and start 15 seconds after the beginning of the new minute and extend to the DT, shown in block 304. In one implementation, there can be a diminishing bar displayed for the player that lasts the length of the DI during which the bar completely disappears, so the player is aware how much time he has to make a decision. There are many ways to visually show the passage of time to the player for this DI and for the WP and other time durations of the method of this implementation.

The player inputs the game-play decision of block 302 before the deadline time. In the event that a player chooses not to make a decision during the DI, the player may have the option to make a decision during the next DI or the following one. Each website server that uses the method of this current implementation may have their own rules and policies in regards to these issues, so the player is fully aware of the rules prior to playing the game. Any currently available algorithm can be used to convert the random data, as illustrated by a block 308. The random financial data and the algorithm result can be posted so can be easily verified, as illustrated by block 160.

The Deadline time (DT) of block 304 refers to the time after which the player can no longer make an input into the website server or take other actions to affect the website server that was permitted during the DI.

The Waiting Period (WP), shown in block 116, refers to the length of time between DT and the Time of Data Use (TODU explained below) shown in block 3060. Because of the nature of electronic communications between a players computer, Internet connection speed, and website server processing, none of these numbers would be exactly precise. For example, suppose a decision by the player to take a card was received 5 seconds after the DT by the website server. The server would reject the decision and inform the player of such. There would still be at least 15 seconds prior to the TODU and it would be very difficult to argue that the website server somehow knew at the time the server sent the rejection to the player knowing the website would have an advantage.

Speed of receiving financial data is important. Because there are many financial market data providers all over the world now, accessibility of financial data is much easier today. Low latency is a frequent topic among capital markets because algorithmic trading requires firms to react to market events quicker than the competition to increase profitability of trades. Many companies that deliver market data are using the words “low latency” to describe latencies under 1 millisecond. Market data that is just a few hundred milliseconds tardier is thought to cause slower trading decisions and lost opportunities in the world of automatic trading. This difference is important to the method of this implementation because the difference between the fastest delivery of market data and the average delivery of real market data is within a few hundred milliseconds but very easily within 2 seconds. The average player can be reasonably sure that 30 seconds prior to, for example, 11:00:00, no one will know the tenths and hundredths place values of the S&P 500 Index value that will be disseminated at 11:00:00. In this scenario, latency is much less of an issue than in stock trading, because the decision deadline occurred 30 seconds prior to 11:00:00. So, if the S&P 500 Index value that is published at 11:00:00 is acquired at 11:00:08, it will not change the decision that occurred before the deadline and it will not change the result. So, latency of a few seconds is unimportant to the method of this implementation, in stark contrast to the world of automatic trading. For example, waiting period between the time of placing a bet until financial data is obtained is approximately in the range of twenty seconds to 120 seconds. This waiting period is long enough to insure that financial data is unknown to all parties at the time the bet is placed, but short enough to feel responsive to a player.

Time of Data Use (TODU), illustrated in block 306, refers to the time that real financial data is published. This TODU would normally be the data provided by the various real time financial data providers; each data provider may have slightly different numbers for various stock financial data but a given online game website would use a single provider and the financial data provider would be consistent in their delivery of this data. Also, index data is usually prepared by one company and then disseminated and so highly unlikely that different financial providers would have slightly different numbers for the exact same time for index data.

The S&P 500 index value is updated every 15 seconds during trading sessions and is disseminated by Reuters American, Inc. As an example, the S&P 500 index may be 1300.12 at 11:00 am and zero seconds, or 11:00:00 (ISO 8601 notation). Since the S&P 500 index is updated every 15 seconds, when we refer to the 11:00 am and zero seconds (11:00:00), we are referring to the S&P 500 index number during the time period 11:00:00 to 11:00:15. It may be 1301.49 at 11:00:15 to 11:00:30. No one will know, 30 seconds prior to 11:00:00 am, what the tenths number and hundredths number of the S&P 500 Index will be at exactly 11:00:00 am if the market is open and being traded. Time notations will use the International Standard ISO 8601 to help avoid confusion. ISO 8601 does not specify, whether its notations specify a point in time or a time period. This means for example that ISO 8601 does not define whether 09:00 refers to the exact end of the ninth hour of the day or the period from 09:00 to 09:01. In the method of the current implementation, both parties need to be aware of the time notation and agree on its definition before the game is played. For example, the S&P 500 index is updated every 15 seconds and when we refer to the 11:00:00, we are referring to the S&P 500 index number disseminated during the time period 11:00:00 to 11:00:15, which will be the TODU in this particular example.

Time when Data is Available 206 (DIA) would be very similar to TODU but due to latency of different providers, could vary by up to a few seconds (highly unlikely), assuming the house uses a provider of real time financial data with low latency.

Some players may believe that certain financial data could be known by large financial institutions and that the tenths and hundredths data from the data at TODU could be known at the Deadline Time (DT). Although, to know this data even 5 seconds in advance is probably impossible, the waiting period (WP) duration can always be increased and can even be placed a day in advance. However, what player would want to receive one card every 24 hours? It would be extremely hard to argue that even the largest financial institutions would be able to predict the tenths and hundredths decimal place numbers of the S&P 500 Index even 5 seconds before. To be able to predict those same numbers (when the market is open and moving) 30 seconds in advance would be virtually impossible. If there were individuals or financial institutions that could predict those tenths and hundredths place value numbers 30 seconds prior to the TODU, they could make millions of dollars every minute in the market itself. With the system and method of the current implementation, the player can be assured that no one will know what the tenths and hundredths digit numbers of the S&P 500 Index will be, seconds prior to the TODU.

In this method of using random numbers derived from market data, even if someone receives market data 2 seconds in advance of everyone else, it is irrelevant because the rules of the game require the decision to take the card or not (or other decision based on the random number that will come out) at least 5 seconds before the TODU but usually 30 seconds before TODU.

Certain financial indices change more often in certain incremental amounts (e.g. by 0.10) and so the smallest value digit may not be the most random number. Once it is determined which financial index or value is chosen as the random number generator, the strength of the randomness of the number can be tested by current random number generators. There will be some indices that consistently perform more randomly than others and so will have higher value for the method of the implementation described herein.

As another example, if the S&P 500 Index data at 11:31:00 306 is 13,153.67, the “or the “or both could be used as the random number and converted into a card such as “of hearts” or “of Spades” so the “”and “”can play their game. The player has a certain amount of time to make a decision to take a card. The player must make his decision by 11:30:30 304 (although this gives 30 seconds for the decision to be registered this duration may be shorter or longer as long as there is sufficient time to make sure the players' decision is registered and the “”is certain that the data is not available to either party. Once the player makes the decision and inputs it, there is a small waiting period 116 before the electronic “”arrives. Both the player and the house can be fairly certain that no one knows what random number will be published at 11:31:00. However, both the player and house can be fairly certain that many other independent parties can verify the exact same random number for 11:31:00. Since the S&P 500 index number is formed from 500 companies, being able to predictably manipulate the smallest digits of the S&P 500 Index in a predictable fashion would be next to impossible. So, at 11:30:00, neither the website operator, the player, or anyone else including the publisher of the S&P 500 index, would know what the last two digits of the S&P 500 Index data will be at exactly 11:31:00.

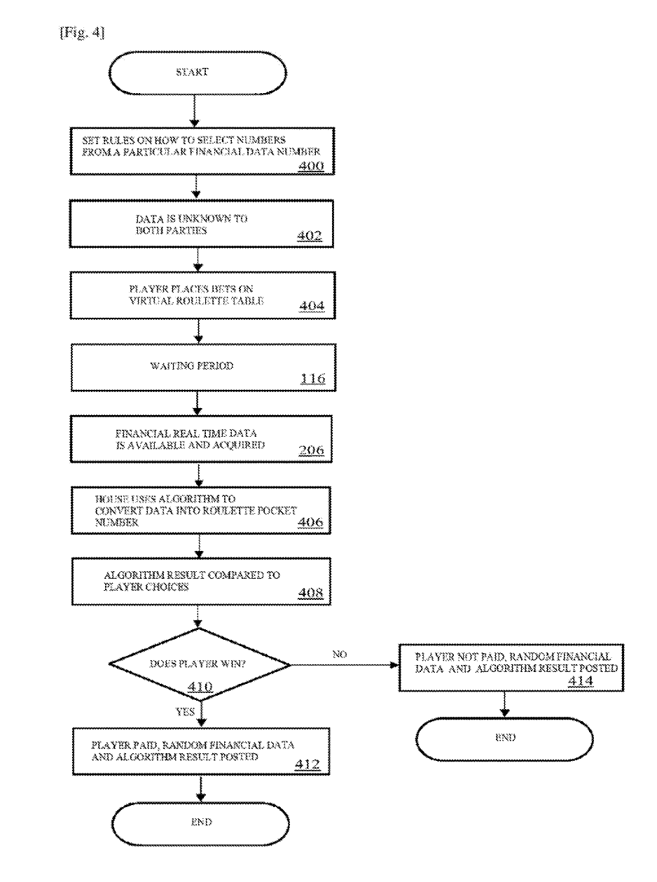

FIG. 4 illustrates an implementation for online roulette. The exact financial index from which the random number will be selected is known prior to the game starting, as illustrated by a block 400. An algorithm can be used to convert the random two-digit number into a roulette number (any number of currently available algorithms can be used), or simply, the roulette numbers 1 thru 36 and “”and “zero” can each be associated with a number. Since there are 38 pockets in roulette but a hundred numbers (in increments of 0.01) between 0.00 and 0.99 (the tenths and hundredths place of the given index selected), each pocket can be assigned two numbers. For example, “”can be assigned 0.00 and 0.01, and “zero” assigned 0.02 and 0.03, and “1” assigned 0.04 and 0.05, etc. That would still leave approximately 24 numbers from the random number range (between 0.00 and 0.99) that are not assigned a pocket. The legend showing the random number assignation to each roulette pocket can be made available at the beginning of the game, on a separate page, on the same webpage, or continuously during play. A rule can be devised such that if no numbers hit, it would be similar to the ball spinning out and the “”is spun again (another random number chosen at a later time). The chances of any of the 38 pockets being chosen is statistically equal and if none of the pockets are chosen and the “”spun again, the same odds are in place and the chances of any of the 38 pockets being chosen is still equal.

To continue the online roulette example, the player would place bets as desired, as illustrated by a block 404. There would be a short period of time during which the player can ask for a “”Then there would be a waiting period 116 during which neither the house nor the player has any idea what number will be selected. There may be (on the display) a simulation of a ball rolling around a roulette wheel, which is also spinning. Before this waiting period, the random data has not been published and is unknown to both parties, as illustrated by a block 402. The index and time that determines the random number to be used is set prior to the game and instructions on how to determine the random number is also placed in the rules of the game, as illustrated by block 400. For example, the Index to be used is the DJIA and the first digit of the random number will be the DJIA Index tenths digit value at the start of each minute and the second digit of the random number will be the DJIA Index hundredths digit value at the start of each minute. Once the random number is obtained from the set index at the set time 206, it is converted into the roulette pocket number, illustrated by a block 406 and it is determined if the player has won, as illustrated by a block 410. The past “”and the results along with the random number associated with that particular result, the index from which the random number was derived and the time of the data can be posted, as illustrated by a block 412. The random financial data and algorithm is posted even if the player does not win, as illustrated by a block 414. The player can easily verify the accuracy of this information by a third party within seconds of the random number selection. The system and method of this implementation is the most completely transparent method of online gaming, because every hand or spin can be verified within minutes and many times within seconds. Current online gaming sites try to exercise transparency on their random generators and software by employing an auditing firm to check the authenticity of their claims. Often this is done at most once a year. The player would still have to believe the auditing firm. Compare that to the current implementation where accuracy and absence of manipulation of the random numbers used can be verified almost immediately after each game or even during the game, using outside sources at a low cost and where the player can determine with their own common sense whether play is fair and honest.

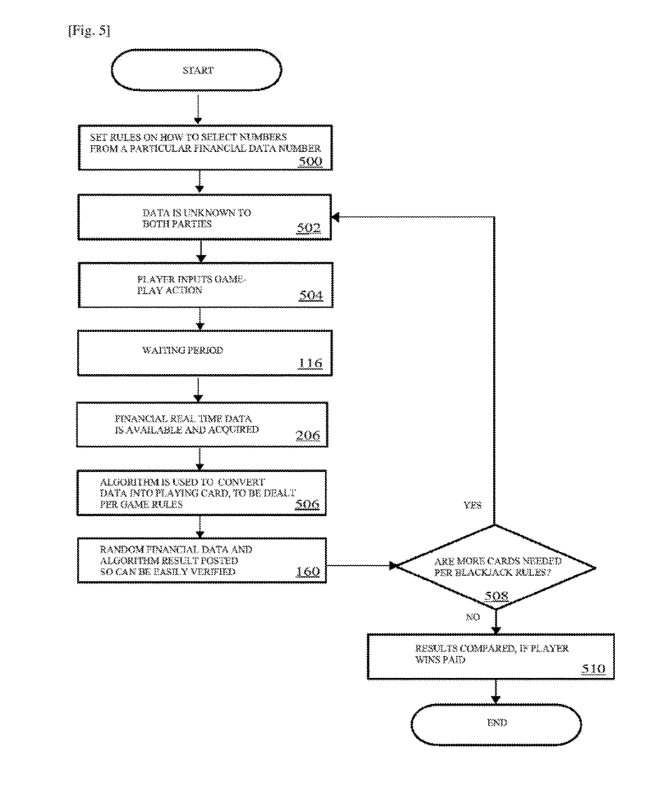

FIG. 5 illustrates an implementation for online blackjack. The exact financial index from which the random number will be selected and the future time of data is selected prior to the start of the game, as illustrated by a block 500. The particular numbers that will be used from the financial index at a future time is unknown to both parties, as illustrated by a block 502. An algorithm can be used to convert the random two-digit number into a card (any currently used algorithms that use random numbers and convert those random numbers into playing cards may be used), as illustrated by a block 506.

In some blackjack games, players prefer a “deck” of cards. In these types of situations, many of the currently available algorithms may be used to provide this “shuffling” of cards. Shuffling is a procedure that is used to make a deck of playing cards random and so provide an element of chance in games involving cards. Shuffling is often followed by a cut to help confirm that the shuffler has not manipulated the potential outcome. Shuffling algorithms are used in current online games involving cards. A computer is able to generate a random permutation of cards. The Fisher-Yates shuffle is simple and efficient and is a computer algorithm capable of providing a very good computerized shuffle for these online games. The Fisher-Yates shuffle still requires a random number to be generated.

A very simple algorithm (if an “”number of decks in dealing cards for blackjack is acceptable) would be as follows; there are 13 cards in each suit and 4 suits so a total of 52 cards. Each of the 4 suits would be associated with a random number from a given Index A (for illustration purposes). So, “”would be assigned 0.01 to 0.25, and “”would be assigned 0.26 to 0.50, and “”would be assigned 0.51 to 0.75, and finally “”would be assigned 0.76 to 0.00. So, at the designated time, if Index A is 1324.56, then 0.56 would be the random number used and it would correspond to “”The suit would then be diamonds. A second index B (for illustration purposes) is pre-selected to provide the random number that will then be assigned for the cards “”through “”Since there are 13 cards but the random range is 0.00 thru 0.99 (100 numbers in the range), each card is assigned 7 numbers and there are 9 remaining numbers. So, “”would be assigned 0.01 to 0.07, the “”card would be assigned 0.08 to 0.14, etc. In this example, if Index B at the designated time is 1445.01, then the random number to be used would be “”and it would correspond to an “”In the event the random number is 0.99 and 0.99 does not correspond to a card, then it would be re-dealt.

The legend or key showing the random number assignation to each card and suit will be available at the beginning of the game, on a separate page, on the same webpage, or continuously during play. A rule can be devised such that if no cards are chosen, the tenths and hundredths place of a third pre selected index is used, and if no cards are chosen even with the third index, a fourth index is immediately used, and so on.

To continue the online blackjack example, the player would place bets as desired, as illustrated by a block 504. There would be a short period of time during which the player can ask for a “”Then there would be a waiting period 116 during which neither the house nor the player has any idea what card will be selected. Prior to the waiting period, the random data will be unknown to both parties, without question, as illustrated by a block 502. The index and time that determines the random number to be used is set prior to the game and instructions on how to determine the random number is also placed in the rules of the game. For example, the index to be used might be the DJIA and the first digit of the random number will be the DJIA Index tenths digit value at the start of each minute and the second digit of the random number will be the DJIA Index hundredths digit value at the start of each minute. Once the random number is obtained from the set index at the set time, illustrated by block 206, it is converted into the card as described above, as illustrated by block 506 and it is determined if the player has won. The past “”and the results along with the random number associated with that particular result, the index from which the random number was derived and the time of the data can be posted, as illustrated by block 160. The player can easily verify the accuracy of this information by a third party within seconds of the random number selection. As more cards are needed according to the rules of the game, this cycle can be repeated, as illustrated by a block 508. At the conclusion, the cards are compared and the player paid if he has won, as illustrated by as block 510.

The game of blackjack usually requires a face down card for the house. In the method of the current implementation, even if a card is given face down, because the card is derived from index data that can then be verified and “”by the player, a face down card would be meaningless and a serious disadvantage to the house. So, the game would be adjusted so that the “”receives the second card after the player has completed his/her decisions.

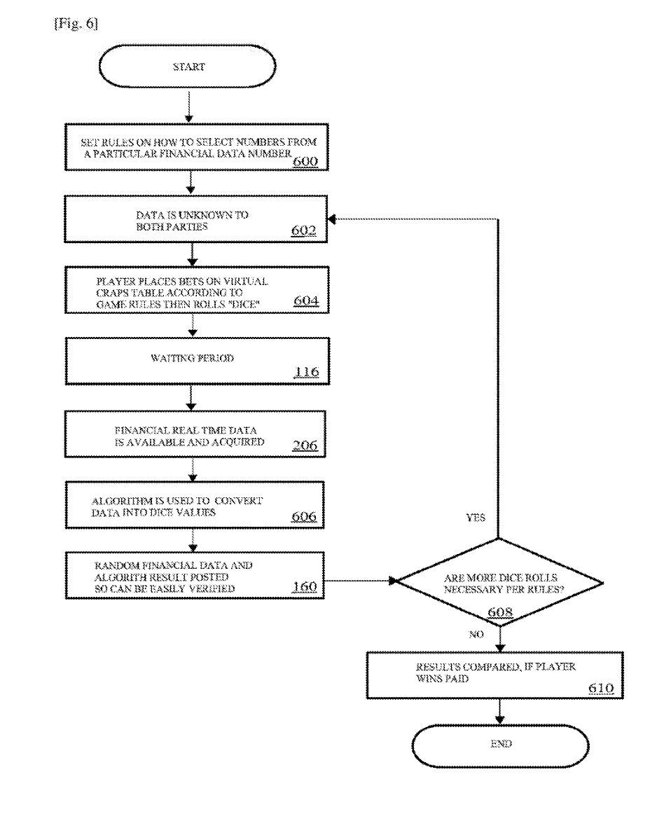

FIG. 6 illustrates implementation for the game of craps. The exact financial index from which the random number will be selected is known prior to the game starting, as illustrated by a block 600. In a block 602, data is unknown to both parties. Other rules for Craps are also clearly laid out. An algorithm can be used to convert the random two-digit number into dice values (1 dot through 8 dots) (any number of currently available algorithms can be used), as illustrated by a block 606.

Another simple method to convert the random numbers into random dice is as follows. Since there are 8 possible dice results from a roll (1 thru 8 dots) and there are two dice, a given Index A (for illustration purposes) is selected and the tenths digit and hundredths digits are used. There are a 100 possible random numbers from 0.00 to 0.99 going up by 0.01 steps. Since there are 8 combinations, each is assigned 12 numbers from the range 0.00 to 0.99. So, a dice with “dot” would be represented by 0.01 to 0.12. A dice with “dots” would be represented by 0.13 to 0.24 and so on. There will be 4 possible random numbers between 0.00 to 0.99 that do not represent any dice.

The second dice would have the same representations but by a given index B (for illustration purposes) which would also have a 100 possible random numbers from 0.00 to 0.99 when increasing by 0.01 steps from 0.00. There will also be 4 possible random numbers that do not represent dice here also.

If either Index ends up at the pre-determined time to select a random number that is not assigned a dice value, then both dice would be “”again, or however the rules would dictate.

The legend or key showing the random number assignation to each dice value can be made available at the beginning of the game, on a separate page, on the same webpage, or continuously during play. The chances of any of the 8 values for each dice being chosen is statistically equal and if none of the dice are chosen and the dice “”again, the same odds are in place and the chances of any of the 8 values for each dice being chosen is still equal.

To continue the online craps example, the player would place bets as desired, as illustrated by a block 604. There would be a short period of time during which the player can “”the dice. Then there would be a waiting period 116 during which neither the house nor the player has any idea what random number will be selected. During this waiting period, there may be (on the display), a simulation of dice that are rolling around on the craps table. The index and time that determines the random number to be used is set prior to the game and instructions on how to determine the random number is also placed in the rules of the game, as illustrated by a block 600. As index real time data becomes available, it is acquired, as illustrated by block 206. If there are more dice rolls/throws necessary, per game rules, then the process is repeated, as illustrated by a block 608. The results are compared and if the player wins, he is paid, as illustrated by a block 610. The past “”and the results along with the random number associated with that particular result, the index from which the random number was derived and the time of the data, can be posted, as illustrated by block 160. The player can easily verify the accuracy of this information by a third party within seconds of the random number selection.

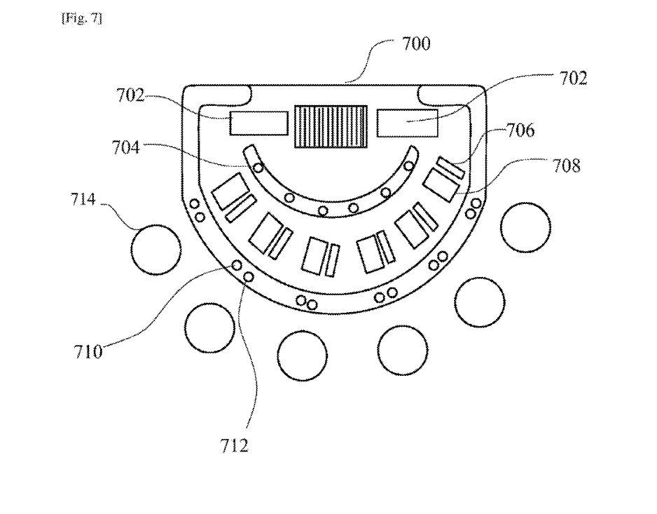

FIG. 7 shows an alternative implementation of the implementation as a Blackjack table 700, but could also be a Roulette wheel or craps table. It is a typical Blackjack table except cards are net dealt out by the dealer, but by the random number producer of the current implementation and displayed by a small video screen 708 on the table 700. Video screen 708 serves as a display that shows a selected game value that is used to determine whether the player is a winner or a loser. Historical numbers generated by the method of this implementation and the associated algorithm result (card) is displayed on a display 706, next to video screen 708 where the cards are displayed. Video screen 706 serves as a display of an historical value for a financial asset used to generate the selected game value. The historical value is generated after the input receives the game input from the player and before the display displays the selected game value. The historical value is generated by a financial exchange independent of the gaming table. The historical value generated by the financial exchange is verifiable by an internet query to an information server. For blackjack, the selected game value is a playing card. For Roulette, the selected game value is a value for a game of Roulette including all the information for a number and color, etc. For craps, the selected game value is a value for a pair of dice.

Players can communicate their game-action decisions via buttons 710 and 712 located next to their chairs 714. Buttons 710 and 712 serve as an input device that receives game input from a player. The particular rules of this Blackjack game, what financial data is used to obtain the random number, what times are used and other pertinent information can also be displayed on displays 702. There may be lights 704 or other method of informing player when he can press the buttons 710 and 712. Lights 704 serve as indicator that indicates to the player when the input device is ready to receive the game input. The lights 704 may be green when he can make a game-play decision. The lights may turn yellow when he is almost out of time and be red to signal that he cannot push any buttons or otherwise relay his decisions. In this fashion, the method and system of this implementation can be used at actual physical locations wherein the player is not in a remote location.

The method of this implementation can be used to generate random numbers for games of chance at actual physical establishments such as Las Vegas, Atlantic City, and Indian Reservation Casinos throughout the U.S, and can include but would not be limited to Blackjack, Poker, Craps, Roulette, Baccarat, Pai-Gow and even slot machines. At physical locations, instead of having a dealer deal cards, a module or table 700 with video screens could be present that provides the cards based can the random number generator of the current implementation. This would prevent concerns of players marking cards that can give a player an advantage, or other similar issues with card tampering.

For all the above described implementations, receiving financial data from the data providers can be accomplished in several ways. For example, an application program interface (API) can be used. An API is a set of routines, protocols, and tools for building software applications. The API specifies how software components should interact and are used when programming graphical user interface (GUI) components. There are several types of APIs for operations systems, applications, or websites. The API is software code written as a series of XML messages. An API specifies how software components should interact with each other.

XML (Extensible Markup Language) is a markup language that defines a set of rules for encoding documents in a format that is both human-readable and machine-readable. XML has come into common use for the interchange of data over the internet and can be used to request and receive financial data from the data providers.

There are XML messages that correspond with each element required in obtaining data from the financial data provider. Those elements include but are not limited to time, the data provider's name and contact information, the time of request, the information transmitted, the time the information is provided, et cetera. All these elements could be maintained on the earning server and provided to the player after each play (or some elements could even be provided during play) or it could be maintained on the player's computer (or smart phone).

WSDL (Web Services Description Language) is another method that can be used to communicate with the financial data providers. WSDL is an XML format for describing network services as a set of endpoints operating on messages containing either document-oriented or procedure-oriented information. The operations and messages are described abstractly, and then bound to a concrete network protocol and message format to define an endpoint.

Data can also be obtained front the financial data providers using push services. Push, or server push, describes a style of Internet-based communication where the request for a given transaction is initiated by the publisher or central server. It is contrasted with pull, where the request for the transmission of information is initiated by the receiver or client. Push services are often based on information preferences expressed in advance. This is called a publish/subscribe model. A client “subscribes” to various information “channels” provided by a server; whenever new content is available on one of those channels, the server pushes that information out to the client.

For example, constant confirmation and verification of data sent/received can be communicated via the internet to the player's computer or player's mobile devices. This flow of communication of information to the player's computer can include a complete or partial log of data received from the financial data provider to the website server.

A complete log of the particular game being played (e.g., the particular rules of the game, the player's actions, the website server communication with the financial data provider and the website server communication of information/data to the player) can also be provided to the player as the information becomes available. This could be presented on the screen constantly, with the most current information replacing streaming across the display, or pushing the older information up or down on the display as newer information comes in. During game play, various other data can be collected and logged. Logged data can include game instructions (for that particular game played), game settings that were selected by player, game play information, maintenance data, player data, fund/finance accounting data, selection of game, wagering data, game outcome data, security data and audit data.

The most important information would of course be the actual random number (e.g. S&P Index numbers) and this particular information could be presented on the player's display (as soon as available) in a similar design that past wins are displayed in Las Vegas in a real game of Roulette with a real table that has a vertically standing rectangular shaped electronic display that shows winning numbers in red or black or green. In such an implementation, the historical wins can also be displayed in a vertically positioned rectangular-shaped box containing data with the actual S&P index data that was the winning number (with the font of the numbers displayed also in red or green or black depending on the correlation with the wheel and the particular rules/legend of the game). This would be another way of displaying the log of historical wins.

In another implementation, a player can actually choose the types of log information he wants displayed as he plays his particular game and in what manner he wants the log information displayed. The player can choose from prepackaged options that could include simple, basic, extensive, and complete or the player could customize the log, information he desires. A computer receives a selection from the player that indicates a level of detail to be displayed pertaining to historical values to be used for generating game values. An amount of detail displayed for the historical value is based on the selection received from the player.

A “Simple” option for data that the player wants displayed might include more limited information such as the actual random number obtained from the financial data provider and waiting period and deadline time. A “Complete” option for data that the player wants displayed would include much more data and include information such as the game played, the rules for the game, the time that each play is started, the particular index that is being used for the game, the deadline time, the waiting period time with a visual way of showing time elapsing (e.g. progress bar, stopwatch), time of data use, time the website server received information from the financial data provider, etc. The “complete” option can include any data or information discussed in this patent disclosure. Even in the event that a player opts for a “simple” option for data display during the game, the player would always have the option to obtain a text file of all the above logged information in the “Complete” option. This log of communications and information can be made available on the player's display or sent to the player via email or text.

Any description of an implementation herein also includes computer hardware, other hardware and software that already exist in the prior art and may be necessary for the operation of the particular implementation. Each of the above-described implementations and variations thereof of the current implementation provides a system and method for providing almost random or random number that are almost instantly verifiable for games of chance, thereby reducing the concern of rigging and cheating. The present implementation has been described in terms of various implementations solely for the purpose of illustration. Persons skilled in the art will recognize from the description above that the implementation is not limited to the implementations described.

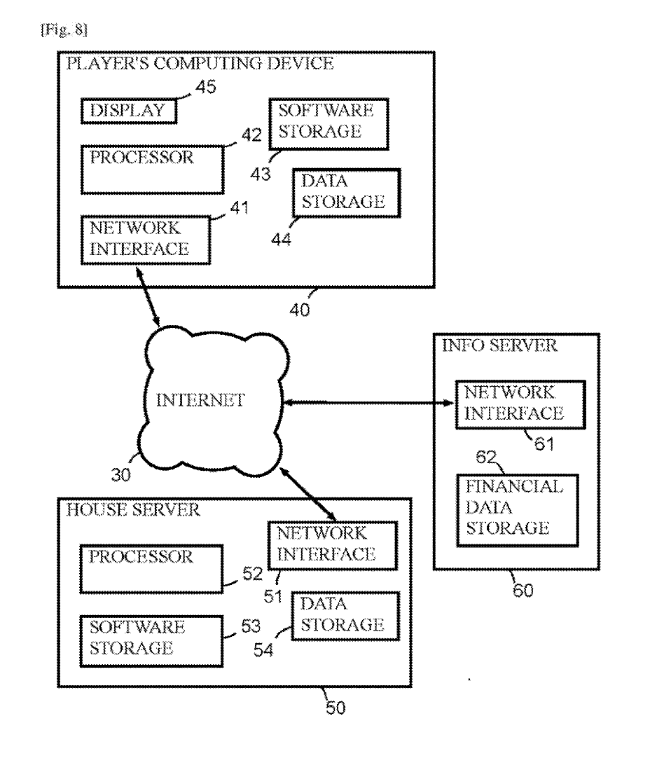

For example, FIG. 8 shows an implementation where a player' computing device 40 includes a display 45, a processor 42, hardware storage for software 43, hardware storage for data 44 and a network interface 41. A house server 50 includes a processor 52, hardware storage for software 53, hardware storage for financial data 62 and a network interface 61. For example, information server 60 is a source of financial information or other information used to calculate random numbers. For gaming table such as blackjack table 700, the function of player' computing device 40 and house server 50 may be combined into a single computing device within the gaming table. Also, while communication is shown through internet 30, alternative networks may be used for communication.

Again, the random number used in this verifiable gaming technique is generally obtained from a financial market and is often a financial index number. A yet another alternate method of producing this number is described in several embodiments below. A combination of stock data can be created in various ways and then the most random portions of that final number can be used in the game. A single stock published price may also be used.

“”In this context, refers to the stock price that is “”for exactly on the top of the minute, e.g. 10:00 am and zero seconds. It refers to a stock price that can at a later time be easily verified and the price that would be present in many historical databases containing that particular stock price historical data. For example, the IBM stock price at 10:00 AM eastern standard time from a date a year ago would have been published and would be readily available from multiple sources as historical one minute data at a later time. However, the IBM stock price at 10:00 AM and 14 seconds eastern standard time from a date a year ago would have been available but would not have be readily available from almost any source as historical data at a later time. Thus, published in this context typically refers to stock data that is released for the public at the top of the minute, similar to the definition of index data. Published index minute data reflects the top of the minute data and not index data from, say, 5 seconds or 7 seconds or 13 seconds after the top of the minute. Published index minute data would be identical at 10:00 am and 5 seconds, 10:00 am and 7 seconds and 10:00 am and 13 seconds. So published stock or index data would be readily available between zero seconds after the top of the minute to 3 seconds after the top of the minute. Published stock price is readily available in minute increments, 5-minute increments, hourly increments and daily increments. Any of these increments may be used with any of the prior embodiments of this invention.

Again, to be clear, if the published price is not used, it is virtually impossible for the player to easily verify the outcome at that time or at a later time. For example, the financial market is used to generate random numbers and the random number used is the S&P index and is generated exactly 15 seconds after the player places his/her wager on the particular game. The player places his/her wager at exactly 10:00 am and 12 seconds. If the server computer acquires the S&P index data at exactly 10:00 am and 27 seconds (15 seconds after the wager is placed), the S&P index data at 10:00 am and 27 seconds may be 2000.29 while the S&P minute index data at 10:00 am is 1999.58. The S&P index constantly fluctuates throughout the minute but the S&P index data from 10:00 am and 27 seconds (2000.29) will not be easily verified or confirmed at a later time. Whereas, the S&P minute index data at 10:00 am (1999.58) will easily be confirmed at a later date on many different available databases. In fact, the S&P minute index data at 10:00 am and 27 seconds will still be 1999.58 in this scenario.

In a less than ideal embodiment, when at least a portion of only a single stock published price is used as the winning (or losing) number (final number) in a casino game, it is possible that the number is NOT random and that some skill is involved in predicting the outcome, even when the tenths and hundredths digit of the stock price is used for the casino game. Of course this depends on the volume of trades for the pail stock and the volatility of the stock in question. A variety of other financial data numbers from the financial markets may also be used including but not limited to stocks, bonds, ETFs, options, futures, hedge fund, commodities, currencies, annuities, and mutual fund prices. In all these circumstances, published data is used to permit verification by the player and even when the tenths and hundredths digit of these numbers are used, the number may not be random and some skill, although small, may make a difference.

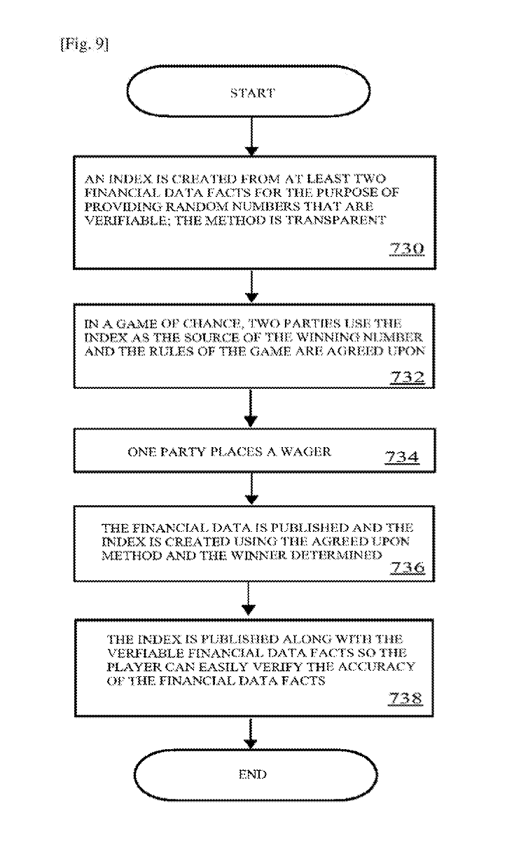

FIG. 9 illustrates an example implementation that provides for creating a random financial index (RFI) number created from at least two financial data facts that is ideally random, and using the resultant RFI number in casino games of chance as illustrated in block 730. In this patent disclosure, “financial index” is defined as at least two financial data historical number facts that are mathematically combined in a consistent fashion and in such a way as to produce at least two digits of the newly created random financial index that are at least almost random. A more complete understanding of the RFI number will become apparent as the derivation is explained over the next several paragraphs and examples are seen. A simple method of creating this random financial index is to add three large volatile minute stock data, such as 10:00 am data for Google, Amazon and Ebay. Most indexes are concerned with a portion of the market. In the creation of this random financial index, we are only concerned with randomness. The rules of the game are set and rules regarding how to select random numbers from the random financial index are set, random numbers that cannot be known to the first party (e.g. “”or the second party (e.g. “”A block 732 illustrates at least two parties playing a game of chance wherein the two parties agree to use the random financial index as the source of the winning number. The most likely digits to be used for game-play from this random financial index will be the tenths and hundredths digits. Network connections can be used to transmit information between the player' client computer and the server. Information can be received by the server over the network connection regarding game-play action from the player. A block 734 illustrates one party placing a wager. There ensues a short waiting period as previously described to assure the random number is truly random. A block 736 illustrates that once the financial data fact is published by the financial exchange, the random financial index is created (using the previously agreed upon method) using the published financial data facts; and the winner is determined. A simple conversion or algorithm can be used to convert the random portion of the random financial index into cards, dice, roulette numbers, etc. During this period, there is a session created between the game client and the server. Information can be transmitted to the remote player' computer regarding the outcome of the game-play action using the random data from the random financial index number. A block 738 illustrates publishing the financial random index along with the verifiable financial data facts so the player can easily verify the random numbers to be accurate and truthful.

Still referring to the creation of a random financial index, typically, stock or bond market indexes are similar to an imaginary portfolio of securities representing a particular market or a portion of it. In this particular embodiment, an index is created which, does not necessarily need to represent a particular market or even a portion, but is a combination of stock data facts (or financial data facts) and the combination increases the randomness of a portion of the final random financial index. In this method, published financial data number facts (that are not copyrighted) are combined to create a final number to be used as the random number for casino gaming. Each individual financial data number fact (that is combined to produce this final number) is easily individually verified using historical financial data easily available from many sources. The final random financial index number is provided in a database format electronically or via online along with the individual financial data number facts (easily verified individual data numbers) so that any player who desires to verify the authenticity of the final number may do so fairly quickly. The individual data numbers can include any of the financial data numbers from the financial markets described anywhere in this application, but excluding index financial data numbers that are copyrighted.

Again, referring to the creation of a random financial index number (RFI), particularly the manner of combining the individual financial data number facts, the method of combining the financial data numbers can include most mathematical functions that are likely to result in random or almost random numbers. Any portions of the individual financial numbers can be combined, as long as the rule is consistent and the method transparent to the player. If the method is too complex, the player may have a more difficult time deriving the RFI number from the two or three individual stock or bond data (or other financial numbers) and duplicating the random financial index number. The collection of historical random financial index (RFI) numbers along with the verifiable financial numbers used to derive the RFI numbers, can be made easily available online or elsewhere so players can easily validate the authenticity of the RFI.

The portion of the RFI number to be used in casino gaming will likely be the most random portion, which is usually the tenths and hundredths digits. A range of individual data numbers may be chosen for this final number, from 2 to 20, but typically front 2 to 5. If two (2) individual data numbers are chosen to produce the final number to be used in casino gaming, the player only needs to verify two individual data number facts to be certain there is no final number manipulation. As an example, in this situation, the two individual data numbers may be Google stock minute price and Ebay stock minute price. If twenty (20) individual financial data numbers are chosen to produce the final RFI number to be used in casino gaming, the player must tediously verify 20 individual data numbers to be certain that there is no manipulation by the casino.

In another embodiment, the final number may include any mathematical combination of copyrightable financial data (such as indexes) along with financial data facts (that cannot be copyrighted individually). This method may be legally complicated due to possibly needing to license currently available financial index data.

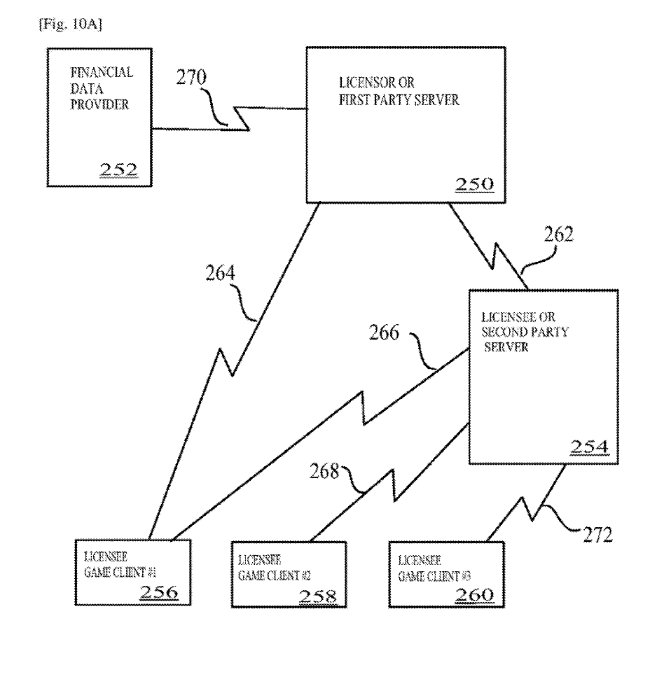

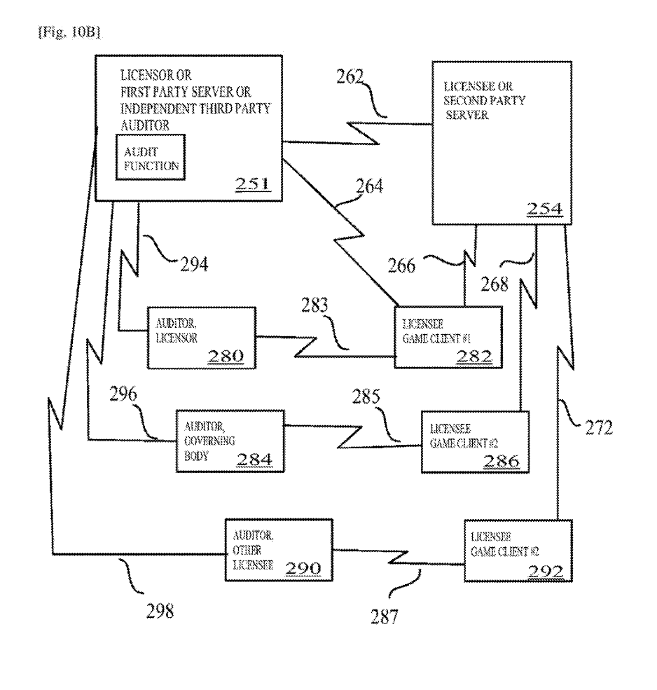

Referring now to the audit portion of the invention as in FIG. 10A, a concern may arise when a second party (licensee or casino) of block 254 agrees to use financial data from the first party (licensor) illustrated in block 250 and the second party agrees to pay the first party for the use of that financial data. The financial data is originally delivered to the first party server from the financial data provider as illustrated in block 252. It can be difficult to assess the quantity of financial data used by the second party (especially if the second party has many game clients, shown in block 256, 258 and 260) and concomitantly, how much the second party is obligated financially to the first party. The second party server may communicate directly with the first party as in block 262. The game client of the second party may communicate directly with the licensor server as in block 264 and also with the second party server as in block 266, although typically a licensee would prefer a game client to only communicate as in block 266 and not directly to the licensor server as in block 264. The audit method of this invention may use either a direct channel of communication or via the licensee server as in block 266, block 268 and block 272. The game client may also only communicate with the second party to receive the financial data as in block 268 and block 272. In another scenario, the second party game client may communicate only with the first party server. There may be many game clients per licensee and there may be many other licensees. The concern is that the licensee receives the financial data used for play in the game clients and then duplicates the financial data for the game clients or in some other fashion prevents proper accounting of the actual amount of financial data used for their game clients.

In the method of the current invention, an audit code is provided along with the financial data and the first party requires that the audit code, when provided, be posted along with at least part of the financial data provided. For example, if the second party has 100 game clients and gaming (typically casino gaming) is occurring in each of the game clients, those game clients operated by the second party would require the first party to provide the random portions of the financial data as a random number generator. Each game client would require financial data from the first party server and for each game play in each game client, the second party server computer operating that particular game client, would request from the first party the financial data as needed. Each request by each game client of the second party to the first party server can result in a financial charge to the second party; it is also possible to make various other financial arrangements between the first party and second party for the financial data provided and used. However, good accounting of the amount of financial data used will be useful in any financial arrangement between the two parties.

The concern is that the second party may merely copy the financial data received from the first party and distribute the financial data over its many game clients. This will result in significant revenue loss to the first party. Thus, there is a need to audit the accuracy of single virtual gaming game client use of the financial data provided by the first party. A good auditing process helps police the system to ensure that the agreed upon rules are being enforced and cheating identified easily and quickly. Auditing processes have been developed to systematically determine compliance with rules.

Again, the main purpose of this auditing process is to determine that the second party is abiding by the agreement and paying for the use of the data provided. All the various embodiments may include a license agreement with typical software audit methods (e.g. requiring all logs of session data, etc) in combination with the method of the current invention. Each hand of each game play in every game client requires a random number that is provided by the first party upon a request by the second party. In the event that the second party decides to illegally use the random number provided for game client one (for example) and use that same number for game client two, then the second party would be in breach of the contract and would be paying less in revenue to the first party. The audit process is to uncover game clients that are not using random numbers provided b the first party server.

The use of financial index data for online casino gaining is a yet untapped market. It is also imperative that a method be designed to protect against theft or copying of the financial data provided. However, there is a practical limit to the resources that can be devoted to preventing illegal use of the financial data provided. At some point, preventing illegal use of this data is no longer economically feasible because the increased expense of the additional protection does not return sufficient revenue to justify the cost. Thus, effective security or audit measures that are low cost but effective are highly desirable. There are many online games that can be played using a computer system coupled to a communication network (e.g., the Internet). These games can include traditional games of chance, games of skill, and casino-type games, and others. All these types of games can be implemented using financial data as the random number generator as previously discussed. The party that provides the financial data (to the game providers) will benefit from the auditing system and method of this current invention.

A significant problem of most auditing programs is the time and energy involved in maintaining an ongoing audit program. In the method of the current invention, when the current audit code system and method is used, the likelihood of compliance to the license agreement by the licensee is greatly increased because of the ability of the licensor to randomly audit the licensee' compliance in a non-obtrusive fashion. If each game client that has a valid license from the first party had to be audited constantly, the audit costs would be overwhelming due to the large volume of financial data requests by each of the many game clients. The method of the current invention minimizes the actual number of audits required while still maintaining a statistically high compliance rate among the many game clients. This method will dramatically minimize the number of game clients that must be audited and drastically reduce the costs of running an audit program. The results of the audit using this method will result in a dramatic reduction in time spent auditing, increase the compliance with the rules (as determined between first party and second party, whether it is pay per use of the financial data or other financial agreements tied to the amount of financial data used by the second party), and can lead to a result with an overall summary that can include the calculation of financial impact that may be used for determining a financial settlement.

Referring now to FIG. 10B, in a subtle but important variation of the method, more than one auditor may be able to audit various licensee' game clients. For example, the licensor will without question want to be able to audit licensee game clients as shown in block 280. The licensor/auditor becomes a player of licensee of block 254 and the licensor/auditor downloads the necessary (if required) software from licensee and initiates a game client session 268. The licensee will not be aware that game client 282 is an auditor. The licensor/auditor 280 may then request an audit code change 294 from licensor 251. As can be seen in block 251, the function of block 251 could be performed by an independent auditor also or any other third party. Whether game client 282 receives the combination data of financial data and the audit code via the licensee 268 or directly from the licensor 264 is not important. The licensor/auditor monitoring the game client 282 should immediately see his/her requested audit code change. This monitoring 283 can be directly observing the screen or via other forms of electronic communication described herein. Also, a regulatory governing body 284 may want to also be able to audit various casino game clients to confirm fairness and to oversee both the licensor and the licensee. The governing body may control a game client 286 and repeat the above process of requesting an audit code change 296 to the licensor server 251 and observing the game client 286 for the updated audit code. Again, this monitoring/observing 285 can be done directly observing the screen or via other forms of electronic communication (indirectly) described herein. Licensed casinos 290 may want to confirm that OTHER licensed casinos are not in breach of their respective license agreements and may also control a game client 292 and again use the same method to audit by sending a code 298 and observing game client 292 for the correct audit code change as requested. Again, this monitoring 287 can be directly observing the screen or via other forms of electronic communication described herein. Although only one licensee is depicted in this diagram, many other licensees may also be communicating with the licensor and audited in the same fashion.

There are many advantages of a central server auditing this process as in FIG. 10B. There are efficiencies of scale because many eyes will be observing both the ongoing creation of the RFI number to be used in casino gaining (although other financial data as previously described may also be used) and because players will only have to use one contact information to audit the particular casino they play and over time players will develop trust with the licensor. Most of the advantages imbued by creating a standard also apply to the audit method of this invention in both a central server model and a model where the audit function is present within the server of the licensee. The advantages are clearly greater in a central server model. Creating a centralized audit function for casino gaming using financial data can dramatically increase trust with players and dramatically increase efficiency in oversight of the complete audit process itself. In the embodiment wherein the audit function is present in the licensee server, the licensee permits various auditing bodies (such as regulators, auditors, competitors) to have access to create audit codes and use the audit function within the licensee server.

All these parties may be able to use any of the many embodiments of this audit system invention, with permission from the licensor. So, multiple parties may use the audit system simultaneously or separately in time. Each party may, with appropriate permissions from the licensor, access only the portions of the server that relate to auditing and each party may even create their own audit code to send, increasing their confidence that the auditing is reliable and trustworthy. The audit code may be pre-determined by the auditing party or created immediately before input into the licensor server.

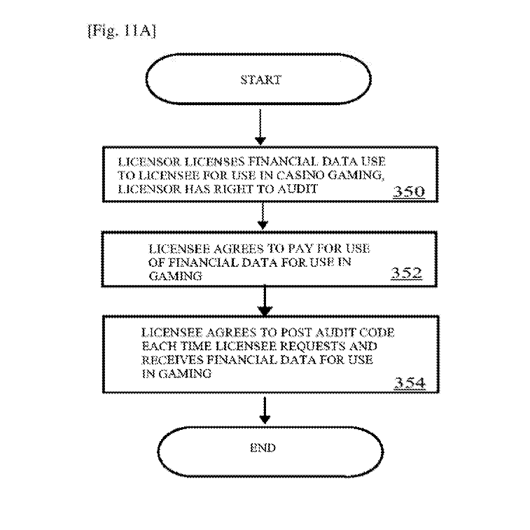

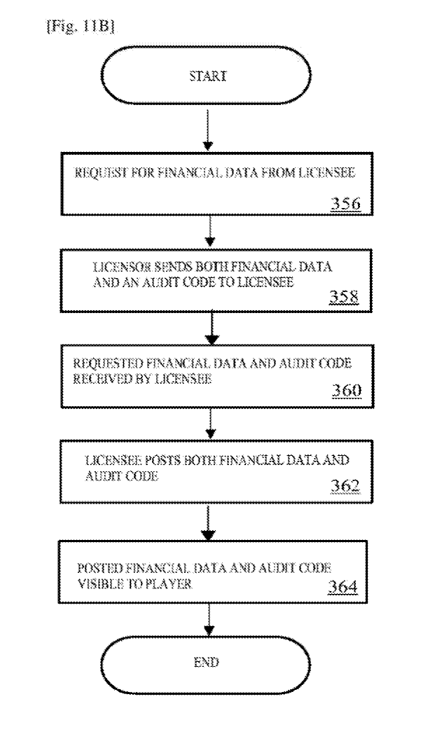

Referring now to FIG. 11A, in this preferred embodiment, the auditing method of the current invention proceeds as follows. The licensor (first party) has signed a contract with the licensee (second party) wherein the licensor has a right to audit the licensee as in block 350 and the licensee has agreed to pay licensor for use of the financial data that licensor provides as in block 352. Furthermore, licensee has agreed to post the audit code provided by licensor illustrated in block 354, each time licensee requests and receives financial data from the licensor. The licensee has agreed to post the audit code along with the financial data that was provided so that a third party can easily access the audit code within a few seconds or sooner of when the twin pair of numbers (financial data and audit code) are provided by the licensor. The licensee may also be required to post historical audit codes with respective time. Not every agreement between the licensor and licensee will have all components above but each agreement will in some form license the use of the financial data for use in casino gaming. The licensee may also be required to post a unique identifier for the specific game client. In the event the first party discovers a game client without a unique identifier, it will be difficult for the first party to assess using the audit method of this invention, whether the game client without a unique identifier label is in compliance with the licensing agreement or not.

The third party may be any person that can access licensee' games. The third party may also be a person that was acting at the request of the first party (or licensor in this situation). Any player that had access to a licensee' game client would be able to initiate a session, be provided a unique identifier and be provided an audit code.

Referring to FIG. 11B, a second party requests financial data from a first party, as shown in block 356. The first party then sends financial index data back to the second party and also sends an audit code to the second party, as illustrated in block 358. The second party receives the requested financial data and audit code from the first party as shown in block 360. Second party then posts both financial data received and the audit code as shown in block 362 so that both pieces of information are available to the player who has initiated the game session where the information is posted as illustrated in block 364.

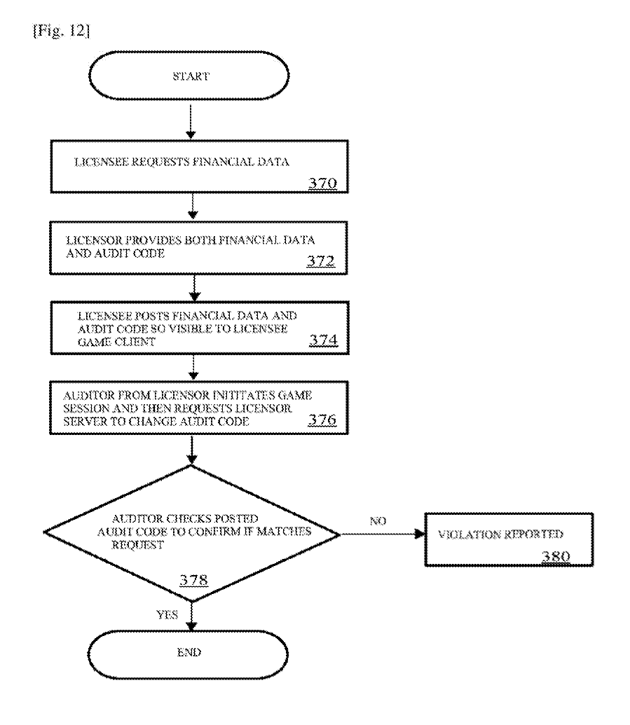

Now, referring to FIG. 12, the method of the current invention generally occurs as follows. A game client of licensee (second party) requests financial data, as illustrated in block 370. Licensor (first party) provides, via the internet, the particular financial data requested and an audit code during a session of the game client, as shown in block 372. Game client of licensee (second party) then posts at least part of the financial data requested along with the audit code as in block 374. Lastly, as block 376 shows, an auditor of licensor can become a registered user of licensee (that has licensed the verifiable financial derived random number technology) and, as a gaming client, initiate a session with the licensor server. Once the session is initiated and a unique identifier is sent to the gaming client, auditor can then request the licensor server to CHANGE the audit code based on the unique identifier and game session as illustrated in block 376. After the auditor makes this new audit code via the licensor server, the auditor should also be able to look at his game client session and see the new audit code appear as in block 378. In the event the auditor does not see the new audit code quickly, it will be apparent that the Casino software is not communicating with licensor server and a violation of the licensing agreement is discovered. The auditor may begin a process of logging the event and alerting the relevant personnel by sending an electronic notification or sending a report as in block 380.

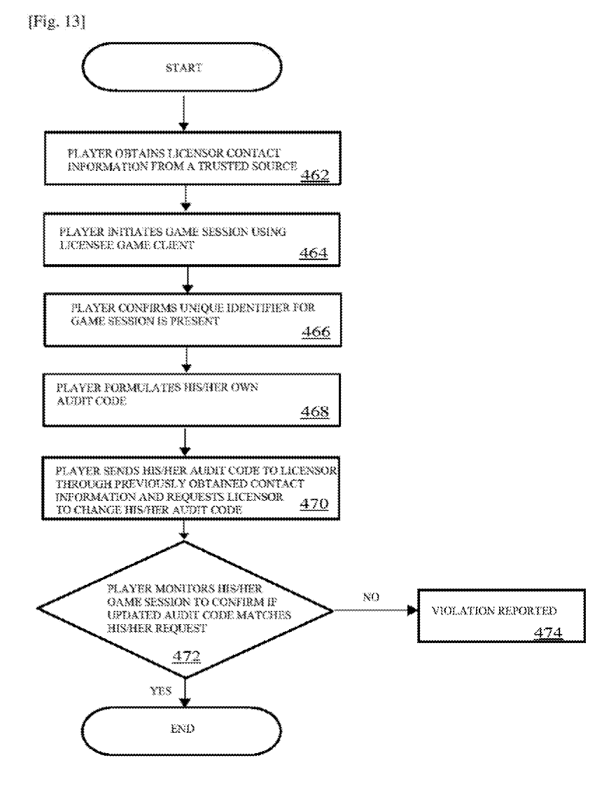

Now referring to FIG. 13, in another embodiment of the method of this invention, the player may assist. With an authentic licensee, when a game client initiates a casino game, a session begins and communication occurs between the licensee game client and the licensor' server. However, in a fraudulent situation, a casino will have licensed the technology of using financial index data for game play but the game client will not be communicating with the licensor' server. Players can be recruited to assist in the auditing process. Information can be contained on the game client display for the player to send his/her particular unique identifier to an email to the licensor server. This identical information may also be contained with the licensor' website so the player can be assured he/she is sending information to an authentic contact for the licensor shown in block 462. The player can then initiate a game session using the licensee' game client as illustrated in block 464. The player must confirm that there is posted a unique identifier for the game session as in block 466. The player can then formulate an audit code of his/her choosing as in block 468. The player will be assured that no one in the world knows his/her choice and the player will be certain that his/her contact information for communicating this audit code change is on a website well known to be the provider of such financial index data. The player may communicate this audit code change request by various methods including fax, voice call, text, email, instant messaging, or any other well known way of electronically communicating. The player may put in a request to the licensor server that the displayed audit code for his/her game session be changed to an audit code of his/her choosing shown in block 470. If the player monitors his/her game session as in block 472 and the audit code does not change to his/her request, the player may be using a fraudulent game client and can be requested to immediately notify the licensor of this as in block 474. The player may be offered a reward if it is uncovered that the particular casino has been in breach of contract.

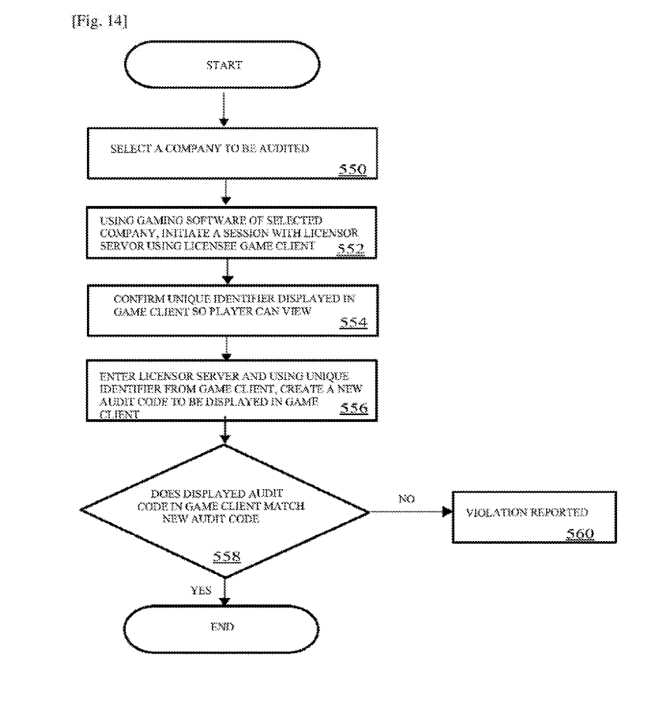

Referring now to FIG. 14, in another preferred embodiment of the invention, a client-server computing environment is used. The computers are networked together which execute a software program. The software program has code resident and executed on both a server computer and at least one client computer. Some portions of the code for the software program may be located on a server computer and other portions of the code for the software program which enables access to the server program may be stored on the client computers. The client computers may access the server over a network. The server computer may provide services to the client computers and provide data including financial data that is published (usually financial index data not exclusively) and an audit code to the client computer (game client). This information will be sent after the server computer receives the financial data from the financial data provider. Throughout the game, the server and game client may communicate as necessary. A problem is that a fraudulent game client computer may attempt to duplicate the provided financial data and the audit codes by copying a valid audit code from a compliant game client. If the client computers share this information, the number of requests to the main server may be significantly reduced and may result in loss of revenue (if revenue is determined at least in part by number of client requests server). To prevent copying of provided financial data, monitoring can occur using audit code method. In normal mode, every game client may display the same audit code while the game client identifier is unique for each game client. During an audit mode, an operator can select a company among the licensed casinos to be audited as in block 550. Using the particular software of the selected casino, initiate a session using a game client as illustrated in block 552. This particular game client' unique identifier will be known to the operator as in block 554. The operator can then enter the licensor server and using the unique identifier, create an audit code especially for that particular game session with the same unique identifier per block 556. Per the operator, if the game client displays the new audit code, the operator can be assured that the game client is communicating directly with the server computer and obtaining the financial data from the server computer and not from a copied source as illustrated in block 558. This audit method can be performed from different IP addresses and using different software from other licensed casinos, as operator desires or as statistically dictated to achieve maximum compliance for audit monitoring expense. In the event the displayed audit code in the game client does not change to the new audit code, the operator reports a violation as in block 560.

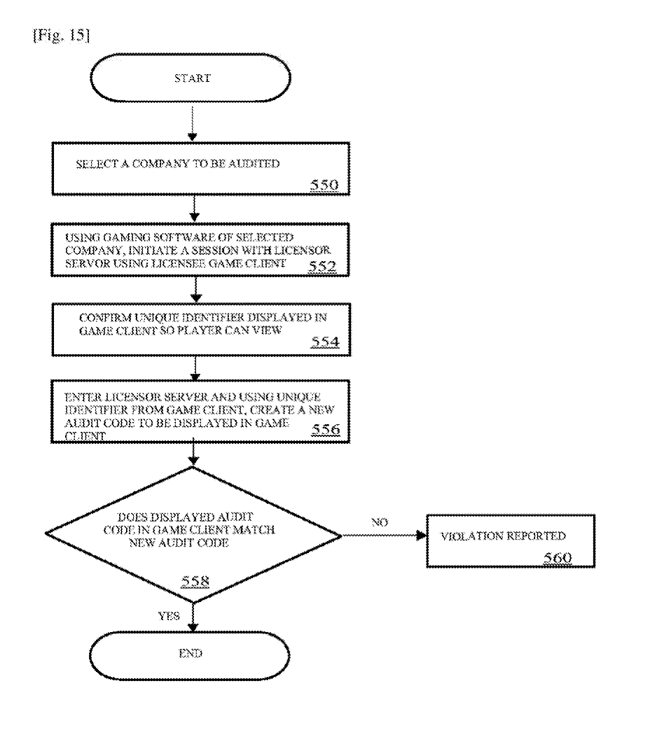

Referring now to FIG. 15, in another particular exemplary embodiment, a computer-implemented system for providing and confirming audit codes along with financial data (operated by the first party or licensor) for online gaining purposes by a second party (or licensee) may comprise: an operator choosing a particular licensee game to audit as in block 562 and downloading the licensee' gaming software of block 564; initiating a game session (block 566) that is purported to use the licensor' financial data; operator then accessing licensor server and changing audit code for this particular session having a unique identifier as in block 568; a licensor receiver module adapted receive via the internet a particular financial index data request as in block 570 from the licensee, the request being in one or more standardized forms to identify at least: (a) an identity of the requestor, (b) an identity of the financial index data requested, and (c) the published time of the financial index data requested; a security module adapted to determine, whether the licensee game client is authorized to make the request and then providing the requested data to the licensee' game client shown in block 572; an automated processing module adapted to: retrieve the particular financial index data requested by the game client and licensor server ability to provide an additional audit code; an output module designed to: (a) provide the particular financial index data requested by the second party game client, (b) provide the audit code to the second party game client also via the internet, wherein the audit code is generally unknown to the second party prior to being sent (but known to the first party), operator comparing the audit code displayed on the game client to the audit code provided by the licensor server as in block 574; and finally, in the event the audit codes do not match, provide a report stating the discrepancy to the licensor as in block 576.

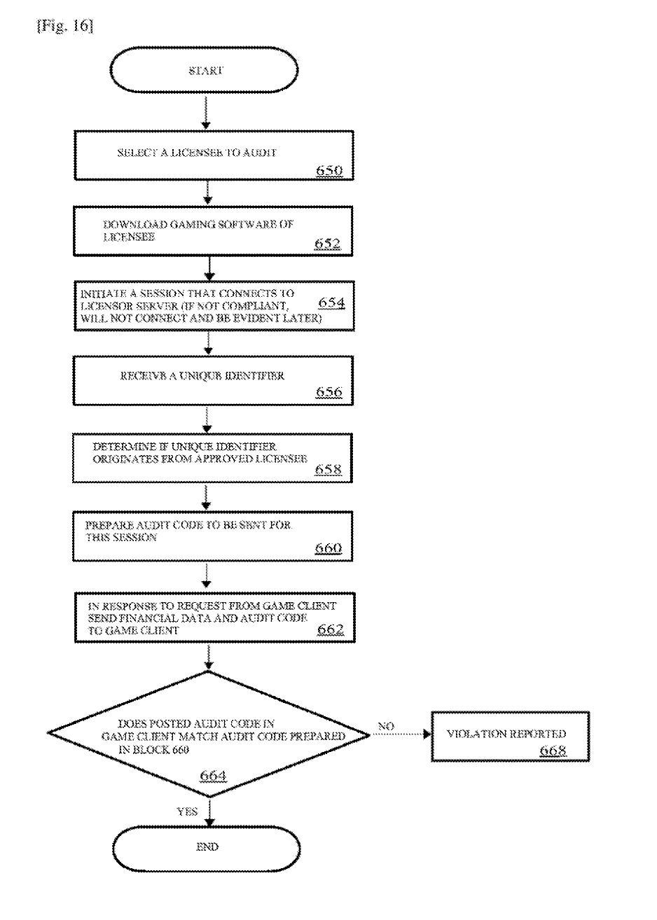

Referring now to FIG. 16, in accordance with another aspect of the embodiments described herein, there is provided a method for auditing financial data usage by a second party game provider, comprising: (a) selecting a licensee second party to audit shown in block 650; (b) downloading the gaming software of that particular second party as in block 562; (c) initiating a session that, if the second party is compliant with the license agreement, connects the game client to the licensor server per block 564; (d) receiving a unique identifier for each game client that has a license to use financial data from the first party as in block 656; (e) determining whether the received unique identifier originates from approved licensee shown in block 658; (f) prepare the audit code to be sent for this session as in block 660; (g) in response to determination that the received unique identifier matches the approved unique identifier, providing the financial data and an audit code to the game client shown in block 662; (g) requiring the game client to post at least part of the financial data and the complete audit code; and (e) assessing whether the audit code posted in the game client matches the one provided by the first party at the time the financial data was sent to the second party as in block 664. In the event the audit codes do not match, a violation report is prepared as in block 668. The audit code will necessarily be unknown to the second party (until the audit code is sent) and known to the first party for the audit process to work successfully.

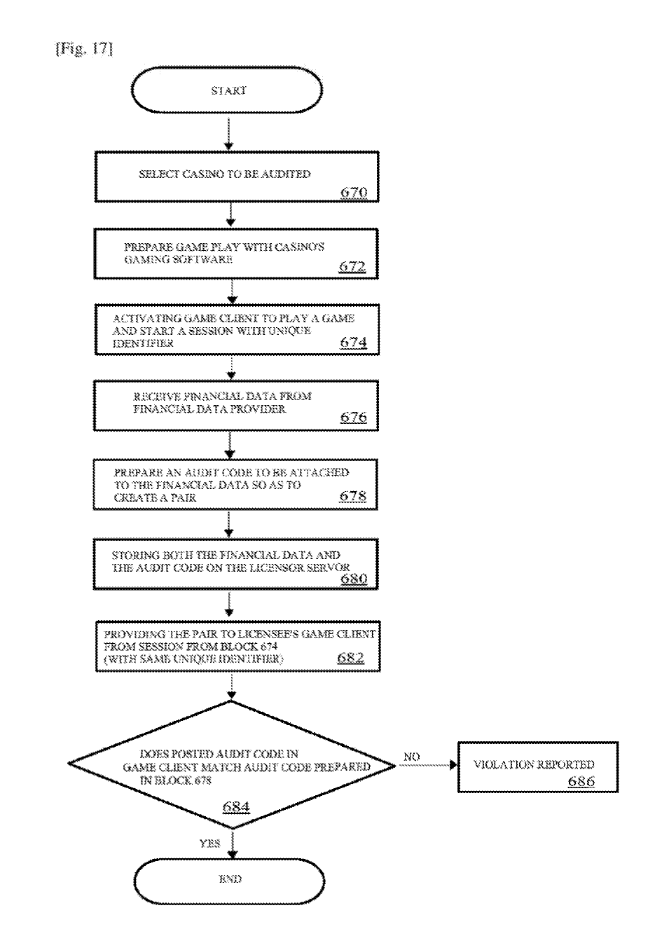

Referring to FIG. 17, according to yet another variation of the present invention, the system and method of providing random or almost random financial data to a second party for the purposes of casino gaming and then auditing the compliance of the second party can be comprised of: selecting a casino to be audited as in block 670; preparing game play with the casino' gaming software as shown in block 672; activating the gaming client to play a game as in block 674; then, on the first party server side, receiving financial data from the financial data provider to the server shown in block 676; preparing an audit code to be attached to the financial data so as to create a pair as shown in block 678; storage means for storing both the financial data and the audit code as shown in block 680; providing the pair to the second party game client upon request (at around the time game client begins game, game client normally initiates a session with the first party server) as in block 682; verifying that the licensed second party is properly displaying the correct audit code in the game client and that the game client displayed audit code matches the previously stored audit code (in the first party server) as shown in block 684; means for creating an alert in case the provided audit code does not match the displayed audit code as in block 686.

In another embodiment, the process may be automated from beginning through the complete audit process. The first party may require the second party to post both the financial data, audit code and game client unique identifier in a pre-determined location so that the first party can automatically extract the necessary data and compare the retrieved data with the actual audit code provided for that game client to see if it is a match. This portion (automatically extracting audit data from a particular game client) may be added to any of the prior embodiments of this invention.

The process of automatically obtaining information from the second party can be performed by the first party' application that is programmed to access the second party' game client on behalf of the first party and collect various information including but not limited to the game client unique identifier, the posted portions of the financial data (the random portions used in gaming are often the tenths and hundredths digit of various financial indices), time of data acquisition, and any other data provided by the game client. Part of the agreement between the first party and the second party may be that the second party agrees that the data collecting bot, spider, web scrapers, or simply by licensor server request to the second party' game client (or second party server) by the first party is permitted. Web scrapers process the semi-structured data pages of targeted websites and convert the data into a much more structured format. Once the data is in this more structured format, the first party can extract or manipulate the data with ease.

From the perspective of a regulatory body, fairness to players is of utmost importance and not necessarily whether or not a particular casino that has licensed the technology is cheating the licensor. In other words, if a casino copies the financial data to be used as the random number for game play, the licensor will make less revenue from this particular casino; the player may not see a difference and will still be able to verify that his or her random number originated from the time and financial index that he/she was told the random number would derive from. However, it will still be difficult for the player to verify every hand himself/herself and the player may not want to do that. With the audit code method of this system within a centralized server, it will also be much easier for governing bodies and players to assess whether a particular licensee is in compliance with gaming rules and truly using financial data in a fair way in casino gaming. For example, a player may decide to play any given number of online casinos and anywhere he/she played, the same contact information could be used to audit (by the player) whether a given casino was actually using random financial data as the source of their random numbers for casino gaming.

A verification system can compare the audit code displayed on the game client to the audit code sent via the licensor' server and determine if the audit codes match and if the game client is authorized for use by the gaming establishment (or licensor). If the results of the comparison show the audit codes do not match, various follow up actions can be initiated. The verification system can log the event and alert the licensor or a governing agency of the unauthorized use.

The audit code used in any of the various embodiments of the current invention can he selected from a group consisting of: random numbers, random letters, random marks, an electronic signature, an encrypted message, a watermark, a picture, a biometric symbol, a security token, a random seal, or a combination of the members of the above group. The audit code method of this invention can be used with any other method of combining financial data with casino gaming.

According to one embodiment, the computer system may include a code generator that generates the audit codes used in any of the embodiments herein. This audit code may be stored, for example, in a database structure of the server. The database may be any of the typical kinds of organizational entities used to store and maintain data. Furthermore, the historical audit codes provided to the second party may also be furnished to another organization (such as, for example, a financial data provider to the first party or another casino that may want to verify the compliance of a fellow competitor casino). Admittedly, a second party that wants to cheat (use the financial data provided without accountability for it by copying it into more than one game client) could then use the provided historical data to update its game clients. However, it would be much more additional work and the data could be provided in a way that is easier for an operator to see, but more difficult to be uploaded into the game client.

A game client' computer may have a log (which may be an analogous version of an internal meter for gaming machines) which is used to track a number of items associated with the game client, including all accounting type numbers. The accounting items can be recorded in real-time and many of these items are closely regulated by various gaming authorities. Logging (or metering) usually relates to monetary activities within the game and the logging activity is desirable for many reasons including the ability to provide accurate accounting and also to comply with legal obligations and gaming industry regulations. From a security and regulatory viewpoint, the ability to easily and accurately audit is extremely useful. Casino gaming activities are very tightly regulated by government authorities and gaming commissions. Thus, if casino game operators can easily show that they their systems cannot be easily manipulated by players or, for that matter, anyone else, then it will be easier for that casino to grow in this heavily regulated market. The log may include various informational items including the game client identifier (may be a serial number), the type of games being played, total money in and out, audit code data and the financial data used for the game. The log can also include any accounting information required by government regulatory bodies. The log information can be stored on the second party' computer (licensee) or on the first party' computer (licensor) or both. The log information may be stored in any of the databases described within this document. This log information within the database may be accessible to one or more servers and may have a connection to a network.

Regarding descriptions or mentions of databases, it will be understood by one of ordinary skill in the art that alternative database structures may easily be employed and other memory structures aside from databases may also be used. The databases, or other memory structures, may be stored locally or remotely from a device that accesses the data in such database or memory structure. Other database formats may be used to store and manipulate the data described. The illustrative arrangements presented may be employed in any number of other arrangements.

Any of the embodiments of the current invention may be used in various combinations with at least one of the other described embodiments or portions of the other described embodiments. Any of the embodiments described may be used in combination with at least one or a portion of one of the described embodiments. The inventive concepts may exist in subsets of the embodiments described and that no embodiment of the invention requires each subset of each embodiment. It will be understood that any other well known established audit method may be used in combination with the methods of using financial data for casino gaming and in combination with the methods of the current audit invention, described herein. Further, various embodiments can include hardware and/or software for performing the operations described.

The concepts described herein are generally but not completely embodied as software programming code. The software programming code embodying various techniques according to the method of the present invention can itself be implemented on any of a variety of known media for use with a data processing system. The code may be distributed on various known types of media or distributed to users from the memory or storage of one computer system over a communications network of any given type to other computer systems for use by users of other systems.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A method for auditing compliance of use of financial data used in a game that derives random or almost random numbers from the financial data, comprising:
providing, through a communication network that implements communication between computers, the financial data to a licensee of the financial data, the financial data being provided by a licensor of the financial data;
using the financial data, by the licensee of the financial data, to derive the random or almost random numbers;
making the financial data and an audit code accessible to a game client through a communication network that implements communication between computers;
requesting the licensor to change the code, the requesting being made by the game client to the licensor; and,
monitoring the audit code made accessible by the licensor to the game client to detect whether the audit code reflects the audit code change requested by the game client.

2. A method as in claim 1 wherein the game client is an auditor that has initiated a game session.

3. A method as in claim 1 wherein the licensor provides to the licensee the audit code which is made accessible to the game client.

4. A method as in claim 1 wherein the game client obtains contact information for the licensor from a trusted source.

5. A method as in claim 1, wherein requesting the licensor to change the audit code includes using a unique identifier from the game client.

6. A method as in claim 1, additionally comprising:
initiating a game session, by the game client, that connects the game client to the licensor;
receiving, by the game client from the licensee, a unique identifier; and,
determining whether the unique identifier is from an approved licensee.

7. A method as in claim 1, additionally comprising:
activating the game client to play the game, including
starting a game session that has a unique identifier that identifies the game session.

8. A method as in claim 1, additionally comprising:
obtaining the financial data by the licensor from a financial data provider.

9. A system that audits compliance of use of financial data used in a game that derives random or almost random numbers from the financial data, the system comprising:
a communication network that implements communication between computers,
a licensor computing server that provides the financial data;
a licensee computing server that receives the financial data from the licensor server and derives from the financial data the random or almost random numbers used in the game;
a game client server that a game player uses to play the game, the financial data and an audit code being accessible to the game client server through the communication network;
wherein to audit compliance of use of the financial data the game client requests the licensor to change the audit code and then monitors the audit code made accessible by the licensor to the game client to detect whether the audit code reflects the audit code change requested by the game client.

10. A system as in claim 9, wherein when the game client initiates a game that connects the game client to the licensor, the game client receives from the licensee a unique identifier which can be used to determine whether the unique identifier is from an approved licensee.
